(19) United States
(12) Patent Application Publication
(10) Pub. No.: US 2004/0130513 A1
(43) Pub. Date: Jul. 8, 2004

(54) Method of driving electronic circuit, method of driving electronic apparatus, method of driving electro-optical apparatus, and electronic device

(75) Inventor: Takashi Miyazawa, Suwa-shi (JP)

Correspondence Address: OLIFF & BERRIDGE, PLC, P.O. BOX 19928, ALEXANDRIA, VA, 22320, US

(73) Assignee: SEIKO EPSON CORORATION, Tokyo (JP)

(21) Appl. No.: 10/724,211

(22) Filed: Dec. 1, 2003

(30) Foreign Application Priority Data
Dec. 16, 2002 (JP) 2002-363862

(51) Int. Cl. G09G 3/30

(52) U.S. Cl. 345/76

(57) ABSTRACT

The present invention provides a method of driving an electronic circuit, a method of driving an electronic apparatus, a method of driving an electro-optical apparatus, and an electronic device with which occurrence of a pseudo contour, deviation of an image, etc. is inhibited when moving pictures are displayed, serving to improve moving-picture characteristics. In particular, after light emission by an organic EL element of each pixel circuit is started, a second switching transistor is turned on during a reset period, whereby a hold capacitor is connected to a power-supply voltage via a driving transistor and the second switching transistor. Thus, the hold capacitor is reset to a reset voltage at or above and the driving transistor is turned off. Accordingly, supply of a current to the organic EL element is inhibited, so that the organic EL element stops emitting light.

### BACKGROUND OF THE INVENTION

1. Technical Field of Invention

The present invention relates to a method of driving an electronic circuit, a method of driving an electronic apparatus, a method of driving an electro-optical apparatus, and an electronic device.

2. Description of Related Art

Recently, interest has arisen for electro-optical apparatuses including organic EL elements since they excel in low power consumption, wide viewing angle, and high contrast ratio compared with other types of apparatuses. Regarding the type of electro-optical apparatuses including organic EL elements, a method of controlling luminance level is known in which the conduction state of a transistor is controlled by applying a voltage in accordance with a data signal (data current) to the gate terminal thereof and thereby setting an amount of current supplied to an organic EL element (e.g., refer to Pamphlet of International Publication No. WO98/36406).

### SUMMARY OF THE INVENTION

In an electro-optical apparatus that employs the above method, a pseudo contour, deviation of an image, and the like can occur when the entire period from selection of a pixel according to a scanning signal to a next selection constitutes a display period or a light-emitting period for displaying moving pictures.

The present invention has been made in view of the problems of the related art described above, and it is an object thereof to provide a method of driving an electronic circuit, a method of driving an electronic apparatus, a method of driving an electro-optical apparatus, and an electronic device with which occurrence of a pseudo contour, deviation of an image, and the like is suppressed to improve moving-picture characteristics.

A method of driving an electronic circuit according to the present invention is a method of driving an electronic circuit including a first transistor having a first terminal and a second terminal, a capacitor connected to a first control terminal of the first transistor, a second transistor for controlling electrical connection between the first terminal and the capacitor, the second transistor having a third terminal and a fourth terminal; and a third transistor having a fifth terminal and a sixth terminal. The method can include a first step of turning on the second transistor and the third transistor, supplying a signal via the sixth terminal and the fifth terminal so that a charge corresponding to the signal is accumulated in the capacitor, and setting a conduction state of the first transistor according to the signal, and a second step of turning off the third transistor and turning on the second transistor to change the conduction state, set in the first step, of the first transistor.

According to this method, in the first step, the second and third transistors are turned on to accumulate a charge corresponding to a signal in the capacitor, and the conduction state of the first transistor is set according to the signal. Then, in the second step, the third transistor is turned off and the second transistor is turned on to change the conduction state, set in the first step, of the first transistor. Thus, the conduction state of the first transistor, set in the first step according to the signal, is changed in the second step before a charge corresponding to a signal, e.g., a data current, is written to the capacitor in a next first step. Thus, even when the data current is small, the data current is written in a short period. Accordingly, the effect of wire capacitance of data lines, etc. is suppressed, so that occurrence of a pseudo contour, deviation of an image, etc. is suppressed when moving pictures are displayed, serving to improve moving-picture characteristics. The pseudo contour herein refers to effects such as deviation in color that is caused, for example, by movement of eyes following an image displayed.

Furthermore, the conduction state of the first transistor can be changed only by controlling on/off of the third transistor and the second transistor, without providing a transistor or a circuit particularly for that purpose. Thus, without particularly providing a transistor or a circuit, even when data corresponding to a low luminance level is written, the data is written in a short time, serving to reduce delay in operation.

In the method of driving an electronic circuit, the first transistor may be turned off in the second step.

According to this method, the first transistor in the conduction state set in the first step according to the signal is turned off in the second step before a next first step is executed. That is, the first transistor is turned off before a charge corresponding to a signal, e.g., a data current, is written to the capacitor in the next first step. Thus, even when the data current is small, the data current is written in an even shorter period, serving to reduce delay in operation even further and to improve moving-picture characteristics even further.

The method of driving an electronic circuit may be such that the second terminal of the first transistor is electrically connected to a predetermined potential and that a potential that is different from the predetermined potential is applied to the first control terminal in the second step.

According to this method, in the second step, a potential that is different from the predetermined potential is applied to the first control terminal to change the conduction state of the first transistor or to turn off the first transistor.

In the method of driving an electronic circuit, the potential applied to the first control terminal in the second step is, for example, a potential obtained by subtracting a threshold voltage of the first transistor from the predetermined potential or a potential obtained by adding the threshold voltage of the first transistor to the predetermined potential.

According to this method, in the second step, a potential obtained by subtracting a threshold voltage of the first transistor from the predetermined potential or a potential obtained by adding the threshold voltage of the first transistor to the predetermined potential is applied to the first control terminal. Accordingly, the conduction state of the first transistor is changed or the first transistor is turned off.

The method of driving an electronic circuit may be such that an electronic element is connected to the first transistor. According to this method, in the second step, the conduction state of the first transistor is changed or the first transistor is turned off, thereby changing operation status of the electronic element or resetting (terminating) an operation of the electronic element.

In the method of driving an electronic circuit, in the second step, the first transistor may be turned off by the potential applied to the first control terminal of the first transistor, thereby resetting an operation of the electronic element. According to this method, in the second step, the first transistor is turned off by the potential applied to the first control terminal, thereby resetting an operation of the electronic element.

A method of driving an electronic apparatus according to the present invention includes a method of driving an electronic apparatus including a plurality of first signal lines, a plurality of second signal lines, a plurality of third signal lines, a power-supply line, and a plurality of unit circuits, wherein each of the plurality of unit circuits includes a first transistor having a first terminal and a second terminal, a capacitor connected to a first control terminal of the first transistor, and a second transistor for controlling electrical connection between the first terminal and the capacitor, the second transistor having a third terminal and a fourth terminal; and a third transistor having a fifth terminal and a sixth terminal. A second control terminal of the second transistor is connected to one of the plurality of second signal lines, a third control terminal of the third transistor is connected to one of the plurality of first signal lines, and the sixth terminal is connected to one of the plurality of third signal lines. The method can include a first step of accumulating a signal supplied via one of the third signal lines in the capacitor as a charge while the second transistor and the third transistor are both on, and setting a conduction state of the first transistor according to the signal, and a second step of turning off the third transistor and turning on the second transistor, and supplying an amount of charge that causes reduction in the conduction state, set in the first step, of the first transistor.

According to the method, the conduction state of the first transistor, set in the first step according to the signal, is reduced in the second step before a charge corresponding to a signal, e.g., a data current, is written to the capacitor in a next first step. Thus, even when the data current is small, the data current is written in a short period. Accordingly, the effect of wire capacitance of data lines, and the like can be suppressed, so that occurrence of a pseudo contour, deviation of an image, and the like is suppressed when moving pictures are displayed, serving to improve moving-picture characteristics. Furthermore, the conduction state of the first transistor can be reduced only by controlling on/off of the third transistor and the second transistor, without providing a transistor or a circuit particularly for that purpose.

In the method of driving an electronic apparatus, the first transistor may be turned off in the second step. According to this method, the first transistor in the conduction state set in the first step according to the signal is turned off in the second step before a next first step is executed. That is, the first transistor is turned off before a charge corresponding to a signal, e.g., a data current, is written to the capacitor in the next first step. Thus, even when the data current is small, the data current is written in an even shorter period, serving to reduce delay in operation even further and to improve moving-picture characteristics even further.

The method of driving an electronic apparatus may be such that the second terminal of the first transistor is electrically connected to a predetermined potential and that a potential that is different from the predetermined potential is applied to the first control terminal in the second step. According to this method, in the second step, a potential that is different from the predetermined potential is applied to the first control terminal to reduce the conduction state of the first transistor or to turn off the first transistor.

In the method of driving an electronic apparatus, the potential applied to the first control terminal in the second step is, for example, a potential obtained by subtracting a threshold voltage of the first transistor from the predetermined potential or a potential obtained by adding the threshold voltage of the first transistor to the predetermined potential. According to this method, in the second step, a potential obtained by subtracting a threshold voltage of the first transistor from the predetermined potential or a potential obtained by adding the threshold voltage of the first transistor to the predetermined potential is applied to the first control terminal. Accordingly, the conduction state of the first transistor is reduced or the first transistor is turned off.

The method of driving an electronic apparatus may be such that an electronic element is connected to the first transistor. According to this method, in the second step, the conduction state of the first transistor is changed or the first transistor is turned off, thereby changing operation status of the electronic element to be reduced or resetting an operation of the electronic element.

In the method of driving an electronic apparatus, in the second step, the first transistor may be turned off by the potential applied to the first control terminal of the first transistor, thereby resetting an operation of the electronic element. According to this method, in the second step, the first transistor is turned off by the potential applied to the first control terminal, thereby resetting an operation of the electronic element.

A method of driving an electro-optical apparatus according to the present invention is a method of driving an electro-optical apparatus including n rows of scanning lines each including a first subscanning line and a second subscanning line, m columns of data lines, a power-supply line, and a plurality of unit circuits arranged in n rows and m columns in association with intersections of the scanning lines and the data lines. Each of the plurality of unit circuits includes a first transistor having a first terminal and a second terminal, a capacitor connected to a first control terminal of the first transistor, a second transistor for controlling electrical connection between the first terminal and the capacitor, the second transistor having a third terminal and a fourth terminal, a third transistor having a fifth terminal and a sixth terminal, and an electro-optical element connected to the first transistor. A second control terminal of the second transistor is connected to the second subscanning line of one of the n rows of scanning lines, a third control terminal of the third transistor is connected to the first subscanning line of the one of the n rows of scanning lines, and the sixth terminal is connected to one of the m columns of data lines. The method can include a first step of accumulating a data signal supplied via one of the m columns of data lines in the capacitor as a charge while the second transistor and the third transistor are both on, and setting a conduction state of the first transistor according to the data signal, and a second step of turning off the third transistor and turning on the second transistor, and supplying an amount of charge that causes reduction in the conduction state, set in the first step, of the first transistor.

According to the method, the conduction state of the first transistor, set in the first step according to the data signal, is reduced in the second step before a charge corresponding to a data signal, e.g., a data current, is written to the capacitor in a next first step. Thus, even when the data current is small, the data current is written in a short period. Accordingly, the effect of wire capacitance of data lines, etc. is suppressed, so that occurrence of a pseudo contour, deviation of an image, and the like is suppressed when moving pictures are displayed, serving to improve moving-picture characteristics. Furthermore, the conduction state of the first transistor can be reduced only by controlling on/off of the third transistor and the second transistor, without providing a transistor or a circuit particularly for that purpose.

In the method of driving an electro-optical apparatus, the first transistor may be turned off in the second step.

According to this method, the first transistor in the conduction state set in the first step according to the signal is turned off in the second step before a next first step is executed. That is, the first transistor is turned off before a charge corresponding to a signal, e.g., a data current, is written to the capacitor in the next first step. Thus, even when the data current is small, the data current is written in an even shorter period, serving to reduce delay in operation even further and to improve moving-picture characteristics even further.

The method of driving an electro-optical apparatus may be such that the second terminal of the first transistor is electrically connected to a predetermined potential and that a potential that is different from the predetermined potential is applied to the first control terminal in the second step. According to this method, in the second step, a potential that is different from the predetermined potential is applied to the first control terminal to reduce the conduction state of the first transistor or to turn off the first transistor.

In the method of driving an electro-optical apparatus, the potential applied to the first control terminal in the second step is, for example, a potential obtained by subtracting a threshold voltage of the first transistor from the predetermined potential or a potential obtained by adding the threshold voltage of the first transistor to the predetermined potential. According to this method, in the second step, a potential obtained by subtracting a threshold voltage of the first transistor from the predetermined potential or a potential obtained by adding the threshold voltage of the first transistor to the predetermined potential is applied to the first control terminal. Accordingly, the conduction state of the first transistor is reduced or the first transistor is turned off.

In the method of driving an electro-optical apparatus, in the second step, the first transistor may be turned off by the potential applied to the first control terminal, thereby stopping supply of a current to the electro-optical element. According to this method, in the second step, the first transistor is turned off by the potential applied to the first control terminal, thereby terminating (resetting) an operation of the electro-optical element.

In the method of driving an electro-optical apparatus, preferably, vertical scanning in which the n rows of scanning lines are sequentially selected one by one is performed at least twice in one frame period, and in the first time of vertical scanning, when one of a first set of scanning lines including either scanning lines on odd-numbered rows or scanning lines on even-numbered rows among the n rows of scanning lines is selected, the conduction state of the first transistor of each of the one row of unit circuits connected to the selected scanning line, among the plurality of unit circuits, is set according to the data signal, and when one of a second set of scanning lines including either the scanning lines on the odd-numbered rows or the scanning lines on the even-numbered rows, not included in the first set, is selected, the second transistor of each of the one row of unit circuits connected to the selected scanning line is turned on to turn off the first transistor, and in the second time of vertical scanning, when one of the second set of scanning lines including either the scanning lines on odd-numbered rows or the scanning lines on even-numbered rows among the n rows of scanning lines is selected, the conduction state of the first transistor of each of the one row of unit circuits connected to the selected scanning line is set according to the data signal, and when one of the first set of scanning lines including either the scanning lines on the odd-numbered rows or the scanning lines on the even-numbered rows, not included in the second set, is selected, the second transistor of each of the one row of unit circuits connected to the selected scanning line is turned on to turn off the first transistor.

According to this method, interlaced vertical scanning is performed to form an image of one frame. Thus, set periods in which the scanning lines are selected and the first transistors are turned on to activate the electro-optical elements are distributed instead of being concentrated, so that loads on circuits are reduced. Also, reset periods in which the scanning lines are selected and the first transistors are turned off to stop operations of the electro-optical elements are distributed instead of being concentrated, so that loads on circuits are reduced. Owing to the reduction in loads, data signals having relatively large values of currents can be supplied. Thus, delay in operation due to wire capacitance of data lines, etc. is further reduced, so that a set period becomes even shorter. Accordingly, data can be written quickly, and even when a data current is small, data can be written in an even shorter time, serving to further reduce delay in operation and to further improve moving-picture characteristics.

In the method of driving an electro-optical apparatus, for example, in one frame period, a set operation and a reset operation are executed alternately each time a scanning line is selected, the set operation causing the conduction state of the first transistor of each of unit circuits on one row connected to the selected scanning line, among the plurality of unit circuits, to be set according to the data signal, and the reset operation causing the second transistor of each of the unit circuits on one row connected to the selected scanning line to be turned on to thereby turn off the first transistor.

According to this method, alternated set-reset vertical scanning is performed to form an image of one frame. Thus, set periods in which the scanning lines are selected and the first transistors are turned on to activate the electro-optical elements are distributed instead of being concentrated, so that loads on circuits are reduced. Also, reset periods in which the scanning lines are selected and the first transistors are turned off to stop operations of the electro-optical elements are distributed instead of being concentrated, so that loads on circuits are reduced. Owing to the reduction in loads, data signals having relatively large values of currents can be supplied. Thus, delay in operation due to wire capacitance of data lines, etc. is further reduced, so that a set period becomes even shorter. Accordingly, data can be written quickly, and even when a data current is small, data can be written in an even shorter time, serving to further reduce delay in operation and to further improve moving-picture characteristics.

In the method of driving an electro-optical apparatus, scanning lines on which the set operation is executed and scanning lines on which the reset operation is executed may be each selected sequentially from the plurality of scanning lines. According to this method, by appropriately selecting a scanning line on which the reset operation is first executed, an active period of an electro-optical element can be changed. Thus, an active period of an electro-optical element with which optimal moving-picture characteristics are achieved can be readily set.

In the method of driving an electro-optical apparatus, for example, the electro-optical elements include three types of light-emitting elements that emit light in red, green, and blue, respectively, and the unit circuits connected to each of the n rows of scanning lines include one type of light-emitting elements that emit light in the same color among the three types of light-emitting elements. According to this method, since each of the scanning lines is connected to light-emitting elements that emit light in the same color among the three types of light-emitting elements that emit light in red, green, and blue, respectively, by varying timing of stopping light emission by the light-emitting element for each of the scanning lines, light-emitting periods of the light-emitting elements can be varied appropriately on a color-by-color basis. Accordingly, change in color balance due to change over time, etc. can be readily adjusted.

A method of driving an electronic circuit according to the present invention is a method of driving an electronic circuit including a first transistor having a first terminal and a second terminal, a second transistor having a third terminal and a fourth terminal, a capacitor commonly connected to a first control terminal of the first transistor and a second control terminal of the second transistor, a third transistor for controlling electrical connection between the third terminal and the second control terminal of the second transistor, the third transistor having a fifth terminal and a sixth terminal, and a fourth transistor having a seventh terminal and an eighth terminal. The method including a first step of turning on the third transistor and the fourth transistor, supplying a signal via the eighth terminal and the seventh terminal so that a charge corresponding to the signal is accumulated in the capacitor, and setting conduction states of the second transistor and the first transistor according to the signal, and a second step of turning off the fourth transistor and turning on the third transistor to change the conduction states, set in the first step, of the second transistor and the first transistor.

According to this method, in the first step, the second and third transistors are turned on to accumulate a charge corresponding to a signal in the capacitor, and the conduction state of the first transistor is set according to the signal. Then, in the second step, the third transistor is turned off and the second transistor is turned on to change the conduction state, set in the first step, of the first transistor. Thus, the conduction state of the first transistor, set in the first step according to the signal, is changed in the second step before a charge corresponding to a signal, e.g., a data current, is written to the capacitor in a next first step. Thus, even when the data current is small, the data current is written in a short period. Accordingly, the effect of wire capacitance of data lines, etc. is suppressed, so that occurrence of a pseudo contour, deviation of an image, etc. is suppressed when moving pictures are displayed, serving to improve moving-picture characteristics.

Furthermore, the conduction state of the first transistor can be changed only by controlling on/off of the third transistor and the second transistor, without providing a transistor or a circuit particularly for that purpose. Thus, without particularly providing a transistor or a circuit, even when data corresponding to a low luminance level is written, the data is written in a short time, serving to reduce delay in operation.

In the method of driving an electronic circuit, the first transistor may be turned off in the second step.

According to this method, the first transistor in the conduction state set in the first step according to the signal is turned off in the second step before a next first step is executed. That is, the first transistor is turned off before a charge corresponding to a signal, e.g., a data current, is written to the capacitor in the next first step. Thus, even when the data current is small, the data current is written in an even shorter period, serving to reduce delay in operation even further and to improve moving-picture characteristics even further.

The method of driving an electronic circuit may be such that the second terminal of the first transistor is electrically connected to a predetermined potential and that a potential that is different from the predetermined potential is applied to the first control terminal in the second step. According to this method, in the second step, a potential that is different from the predetermined potential is applied to the first control terminal to change the conduction state of the first transistor or to turn off the first transistor.

The method of driving an electronic circuit may be such that an electronic element is connected to the first transistor. According to this method, in the second step, the conduction state of the first transistor is changed or the first transistor is turned off, thereby changing operation status of the electronic element or resetting (terminating) an operation of the electronic element.

In the method of driving an electronic circuit, in the second step, the first transistor may be turned off by the potential applied to the first control terminal of the first transistor, thereby resetting an operation of the electronic element. According to this method, in the second step, the first transistor is turned off by the potential applied to the first control terminal, thereby resetting an operation of the electronic element.

A method of driving an electronic apparatus according to the present invention is a method of driving an electronic apparatus including a plurality of first signal lines, a plurality of second signal lines, a plurality of third signal lines, a power-supply line, and a plurality of unit circuits. Each of the plurality of unit circuits can include a first transistor having a first terminal and a second terminal, a second transistor having a third terminal and a fourth terminal, a capacitor commonly connected to a first control terminal of the first transistor and a second control terminal of the second transistor, a third transistor for controlling electrical connection between the third terminal and the second control terminal of the second transistor, the third transistor having a fifth terminal and a sixth terminal, and a fourth transistor having a seventh terminal and an eighth terminal. A third control terminal of the third transistor is connected to one of the plurality of second signal lines, a fourth control terminal of the fourth transistor is connected to one of the plurality of first signal lines, and the eighth terminal is connected to the one of the plurality of second signal lines. The method can include a first step of accumulating a signal supplied via one of the plurality of third signal lines in the capacitor as a charge while the third transistor and the fourth transistor are both on, and setting a conduction state of the first transistor according to the signal, and a second step of turning off the fourth transistor and turning on the third transistor, and supplying an amount of charge that causes reduction in the conduction state, set in the first step, of the first transistor to the capacitor.

According to the method, the conduction state of the first transistor, set in the first step according to the signal, is reduced in the second step before a charge corresponding to a signal, e.g., a data current, is written to the capacitor in a next first step. Thus, even when the data current is small, the data current is written in a short period. Accordingly, the effect of wire capacitance of data lines, etc. is suppressed, so that occurrence of a pseudo contour, deviation of an image, etc. is suppressed when moving pictures are displayed, serving to improve moving-picture characteristics. Furthermore, the conduction state of the first transistor can be reduced only by controlling on/off of the third transistor and the second transistor, without providing a transistor or a circuit particularly for that purpose.

A method of driving an electro-optical apparatus according to the present invention can be a method of driving an electro-optical apparatus including n rows of scanning lines each including a first subscanning line and a second subscanning line, m columns of data lines, a power-supply line, and a plurality of unit circuits arranged in n rows and m columns in association with intersections of the scanning lines and the data lines. Each of the plurality of unit circuits can include a first transistor having a first terminal and a second terminal, a second transistor having a third terminal and a fourth terminal, a capacitor commonly connected to a first control terminal of the first transistor and a second control terminal of the second transistor, a third transistor for controlling electrical connection between the third terminal and the second control terminal of the second transistor, the third transistor having a fifth terminal and a sixth terminal, a fourth transistor having a seventh terminal and an eighth terminal; and an electro-optical element connected to the first transistor. A third control terminal of the third transistor is connected to the second subscanning line of one of the n rows of scanning lines, a fourth control terminal of the fourth transistor is connected to the first subscanning line of the one of the n rows of scanning lines, and the eighth terminal is connected to one of the m columns of data lines. The method can include a first step of accumulating a data signal supplied via one of the m columns of data lines in the capacitor as a charge while the third transistor and the fourth transistor are both on, and setting conduction states of the second transistor and the first transistor according to the data signal, and a second step of turning off the fourth transistor and turning on the third transistor, and supplying an amount of charge that causes reduction in the conduction states, set in the first step, of the second transistor and the first transistor to the capacitor.

According to the method, the conduction state of the first transistor, set in the first step according to the data signal, is reduced in the second step before a charge corresponding to a data signal, e.g., a data current, is written to the capacitor in a next first step. Thus, even when the data current is small, the data current is written in a short period. Accordingly, the effect of wire capacitance of data lines, etc. is suppressed, so that occurrence of a pseudo contour, deviation of an image, etc. is suppressed when moving pictures are displayed, serving to improve moving-picture characteristics. Furthermore, the conduction state of the first transistor can be reduced only by controlling on/off of the third transistor and the second transistor, without providing a transistor or a circuit particularly for that purpose.

In the method of driving an electro-optical apparatus, for example, the electro-optical elements include three types of light-emitting elements that emit light in red, green, and blue, respectively, and the unit circuits connected to each of the n rows of scanning lines include one type of light-emitting elements that emit light in the same color among the three types of light-emitting elements. According to this method, since each of the scanning lines is connected to light-emitting elements that emit light in the same color among the three types of light-emitting elements that emit light in red, green, and blue, respectively, by varying timing of stopping light emission by the light-emitting element for each of the scanning lines, light-emitting periods of the light-emitting elements can be varied appropriately on a color-by-color basis. Accordingly, change in color balance due to change over time, etc. can be readily adjusted.

In the method of driving an electro-optical apparatus, preferably, vertical scanning in which the n rows of scanning lines are sequentially selected one by one is performed at least twice in one frame period, and in the first time of vertical scanning, when one of a first set of scanning lines including either scanning lines on odd-numbered rows or scanning lines on even-numbered rows among the n rows of scanning lines is selected, the conduction state of the first transistor of each of the one row of unit circuits connected to the selected scanning line, among the plurality of unit circuits, is set according to the data signal, and when one of a second set of scanning lines including either the scanning lines on the odd-numbered rows or the scanning lines on the even-numbered rows, not included in the first set, is selected, the second transistor of each of the one row of unit circuits connected to the selected scanning line is turned on to turn off the first transistor, and in the second time of vertical scanning, when one of the second set of scanning lines including either the scanning lines on odd-numbered rows or the scanning lines on even-numbered rows among the n rows of scanning lines is selected, the conduction state of the first transistor of each of the one row of unit circuits connected to the selected scanning line is set according to the data signal, and when one of the first set of scanning lines including either the scanning lines on the odd-numbered rows or the scanning lines on the even-numbered rows, not included in the second set, is selected, the second transistor of each of the one row of unit circuits connected to the selected scanning line is turned on to turn off the first transistor.

According to this method, interlaced vertical scanning is performed to form an image of one frame. Thus, set periods in which the scanning lines are selected and the first transistors are turned on to activate the electro-optical elements are distributed instead of being concentrated, so that loads on circuits are reduced. Also, reset periods in which the scanning lines are selected and the first transistors are turned off to stop operations of the electro-optical elements are distributed instead of being concentrated, so that loads on circuits are reduced. Owing to the reduction in loads, data signals having relatively large values of currents can be supplied. Thus, delay in operation due to wire capacitance of data lines, etc. is further reduced, so that a set period becomes even shorter. Accordingly, data can be written quickly, and even when a data current is small, data can be written in an even shorter time, serving to further reduce delay in operation and to further improve moving-picture characteristics.

In the method of driving an electro-optical apparatus, for example, in one frame period, a set operation and a reset operation are executed alternately each time a scanning line is selected, the set operation causing the conduction state of the first transistor of each of unit circuits on one row connected to the selected scanning line, among the plurality of unit circuits, to be set according to the data signal, and the reset operation causing the second transistor of each of the unit circuits on one row connected to the selected scanning line to be turned on to thereby turn off the first transistor, whereby the electro-optical element stops emitting light.

According to this method, alternated set-reset vertical scanning can be performed to form an image of one frame. Thus, set periods in which the scanning lines are selected and the first transistors are turned on to activate the electro-optical elements are distributed instead of being concentrated, so that loads on circuits are reduced. Also, reset periods in which the scanning lines are selected and the first transistors are turned off to stop operations of the electro-optical elements are distributed instead of being concentrated, so that loads on circuits are reduced. Owing to the reduction in loads, data signals having relatively large values of currents can be supplied. Thus, delay in operation due to wire capacitance of data lines, etc. is further reduced, so that a set period becomes even shorter. Accordingly, data can be written quickly, and even when a data current is small, data can be written in an even shorter time, serving to further reduce delay in operation and to further improve moving-picture characteristics.

In the method of driving an electro-optical apparatus, scanning lines on which the set operation is executed and scanning lines on which the reset operation is executed may be each selected sequentially from the plurality of scanning lines. According to this method, by appropriately selecting a scanning line on which the reset operation is first executed, an active period of an electro-optical element can be changed. Thus, an active period of an electro-optical element with which optimal moving-picture characteristics are achieved can be readily set.

A method of driving an electronic circuit according to the present invention is a method of driving an electronic circuit including a first transistor having a first terminal and a second terminal, a capacitor connected to a first control terminal of the first transistor, a second transistor for controlling electrical connection between the first terminal and the capacitor, the second transistor having a third terminal and a fourth terminal, a third transistor electrically connected to the fourth terminal via the capacitor and electrically connected to the second terminal of the first transistor, the third transistor having a fifth terminal and a sixth terminal, and a fourth transistor having a seventh terminal connected to the second terminal and having an eighth terminal. The method can include a first step of turning on the second transistor and the third transistor, supplying a signal via the sixth terminal and the fifth terminal so that a charge corresponding to the signal is accumulated in the capacitor, and setting a conduction state of the first transistor according to the signal, and a second step of turning off the fourth transistor to change the conduction state, set in the first step, of the first transistor.

According to this method, in the first step, the second and third transistors are turned on to accumulate a charge corresponding to a signal in the capacitor, and the conduction state of the first transistor is set according to the signal. Then, in the second step, the fourth transistor is turned off to change the conduction state, set in the first step, of the first transistor. Thus, the conduction state of the first transistor, set in the first step according to the signal, is changed in the second step before a charge corresponding to a signal, e.g., a data current, is written to the capacitor in a next first step. Thus, even when the data current is small, the data current is written in a short period. Accordingly, the effect of wire capacitance of data lines, etc. is suppressed, so that occurrence of a pseudo contour, deviation of an image, etc. is suppressed when moving pictures are displayed, serving to improve moving-picture characteristics. Furthermore, the conduction state of the first transistor can be changed only by controlling on/off of the fourth transistor, without providing a transistor or a circuit particularly for that purpose. Thus, without particularly providing a transistor or a circuit, even when data corresponding to a low luminance level is written, the data is written in a short time, serving to reduce delay in operation.

A method of driving an electronic apparatus according to the present invention is a method of driving an electronic apparatus including a plurality of first signal lines, a plurality of second signal lines, a plurality of third signal lines, a power-supply line, and a plurality of unit circuits. Each of the plurality of unit circuits can include a first transistor having a first terminal and a second terminal, a capacitor connected to a first control terminal of the first transistor, a second transistor for controlling electrical connection between the first terminal and the capacitor, the second transistor having a third terminal and a fourth terminal, a third transistor electrically connected to the fourth terminal and the first control terminal of the first transistor via the capacitor, the third transistor having a fifth terminal and a sixth terminal, and a fourth transistor having a seventh terminal connected to the second terminal and having an eighth terminal, and wherein a second control terminal of the second transistor is connected to one of the plurality of second signal lines, a third control terminal of the third transistor is connected to one of the plurality of first signal lines, and the sixth terminal is connected to one of the plurality of third signal lines. The method can include a first step of accumulating a signal supplied via one of the third signal lines in the capacitor as a charge while the second transistor and the third transistor are both on, and setting a conduction state of the first transistor according to the signal, and a second step of turning off the fourth transistor.

According to the method, the conduction state of the first transistor, set in the first step according to the signal, is changed in the second step before a charge corresponding to a signal, e.g., a data current, is written to the capacitor in a next first step. Thus, even when the data current is small, the data current is written in a short period. Accordingly, the effect of wire capacitance of data lines, etc. is suppressed, so that occurrence of a pseudo contour, deviation of an image, etc. is suppressed when moving pictures are displayed, serving to improve moving-picture characteristics. Furthermore, the conduction state of the first transistor can be changed only by controlling on/off of the fourth transistor, without providing a transistor or a circuit particularly for that purpose.

A method of driving an electro-optical apparatus according to the present invention is a method of driving an electro-optical apparatus including n rows of scanning lines each including a first subscanning line and a second subscanning line, m columns of data lines, a power-supply line, and a plurality of unit circuits arranged in n rows and m columns in association with intersections of the scanning lines and the data lines, wherein each of the plurality of unit circuits includes a first transistor having a first terminal and a second terminal, a capacitor connected to a first control terminal of the first transistor; a second transistor for controlling electrical connection between the first terminal and the capacitor, the second transistor having a third terminal and a fourth terminal, a third transistor electrically connected to the fourth terminal and the first control terminal of the first transistor via the capacitor, the third transistor having a fifth terminal and a sixth terminal, a fourth transistor having a seventh terminal connected to the second terminal and having an eighth terminal, and an electro-optical element connected to the first transistor. A second control terminal of the second transistor is connected to the second subscanning line of one of the n rows of scanning lines, a third control terminal of the third transistor is connected to the first subscanning line of the one of the n rows of scanning lines, and the sixth terminal is connected to one of the m columns of data lines. The method can include a first step of accumulating a data signal supplied via one of the m columns of data lines in the capacitor as a charge while the second transistor and the third transistor are both on, and setting a conduction state of the first transistor according to the data signal, and a second step of turning off the fourth transistor.

According to this method, the conduction state of the first transistor, set in the first step according to the signal, is reduced in the second step before a charge corresponding to a signal, e.g., a data current, is written to the capacitor in a next first step. Thus, even when the data current is small, the data current is written in a short period. Accordingly, the effect of wire capacitance of data lines, etc. is suppressed, so that occurrence of a pseudo contour, deviation of an image, etc. is suppressed when moving pictures are displayed, serving to improve moving-picture characteristics. Furthermore, the conduction state of the first transistor can be reduced only by controlling on/off of the fourth transistor, without providing a transistor or a circuit particularly for that purpose.

An electronic device according to the present invention is an electronic device wherein a driving method according to the above invention is used. According to the electronic device, the effect of wire capacitance of data lines, etc. is suppressed, so that occurrence of a pseudo contour, deviation of an image, etc. is suppressed when moving pictures are displayed, serving to improve moving-picture characteristics. Furthermore, electric power load is reduced, allowing stable and high-speed operation.

### BRIEF DESCRIPTION OF THE DRAWINGS

The invention will be described with reference to the accompanying drawings, wherein like numerals reference like elements, and wherein:

FIG. 1 shows a block circuit diagram showing an organic EL display according to a first embodiment;

FIG. 2 shows a circuit diagram showing a display panel section according to the first embodiment;

FIG. 3 shows a circuit diagram showing a pixel circuit and a data-line driving circuit according to the first embodiment;

FIG. 4 shows a timing chart for explaining a driving method according to the first embodiment;

FIG. 5 shows a timing chart for explaining a driving method according to a second embodiment;

FIG. 6 shows a timing chart for explaining a driving method according to a third embodiment;

FIG. 7 shows a circuit diagram showing a pixel circuit and a data-line driving circuit according to a fourth embodiment;

FIG. 8 shows a circuit diagram showing a pixel circuit and a data-line driving circuit according to a fifth embodiment; and

FIG. 9 shows a perspective view showing the configuration of a cellular phone.

### DETAILED DESCRIPTION OF PREFERRED EMBODIMENTS

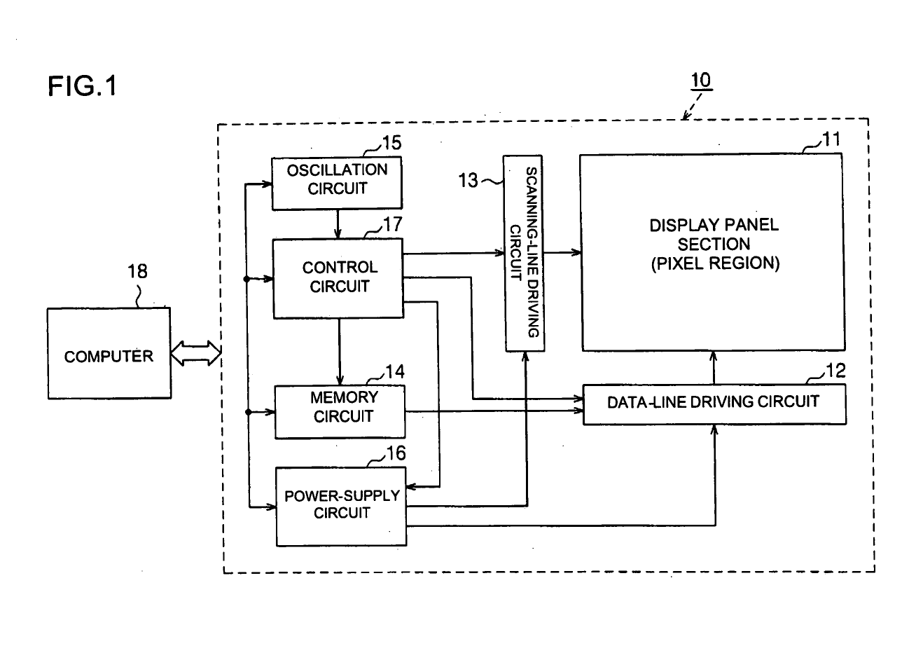

Now, embodiments of the present invention will be described with reference to the drawings. A first embodiment in which a method of driving an electronic apparatus or electro-optical apparatus, according to the present invention, is applied to an organic EL display will be described with reference to FIGS. 1 to 4.

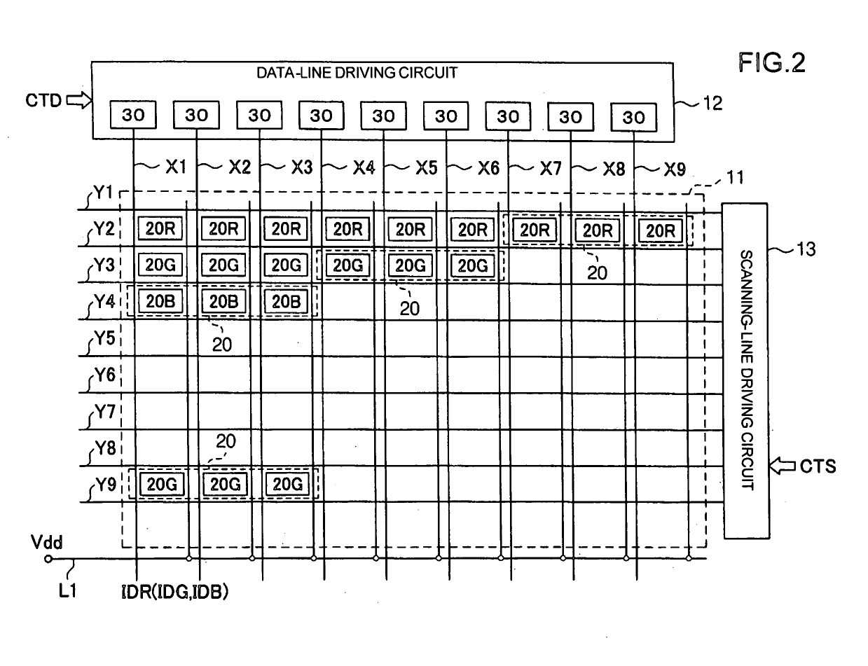

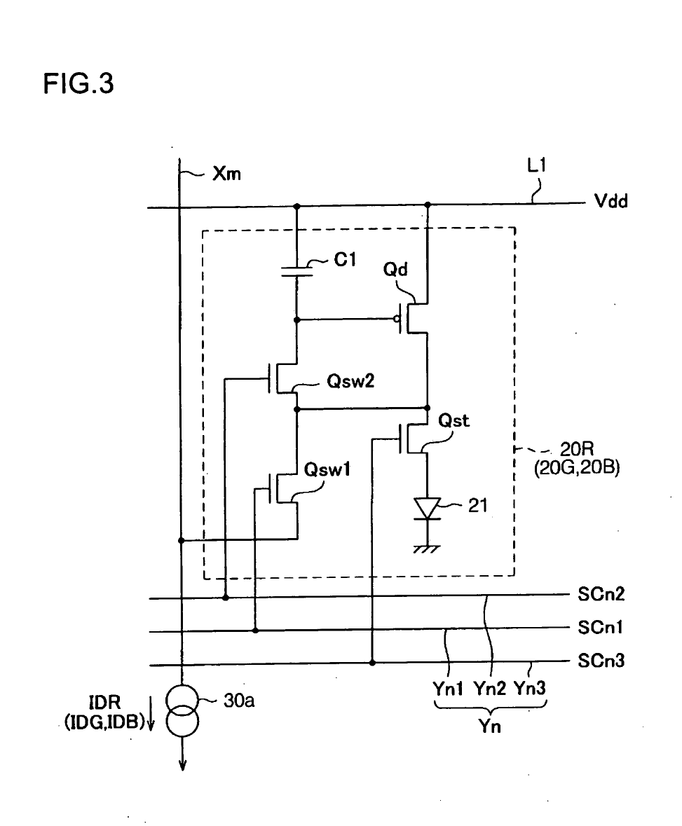

FIG. 1 is an exemplary block circuit diagram showing the circuit configuration of an organic EL display 10 as an electronic apparatus or electro-optical apparatus. FIG. 2 is an exemplary block circuit diagram showing the internal circuit configuration of a display panel section and a data-line driving circuit. FIG. 3 is an exemplary circuit diagram showing the internal circuit configuration of a pixel circuit.

Referring to FIG. 1, the organic EL display 10 includes a display panel section 11, a data-line driving circuit 12, a scanning-line driving circuit 13, a memory circuit 14, an oscillation circuit 15, a power-supply circuit 16, and a control circuit 17. The components 11 to 17 of the organic EL display 10 may be implemented respectively by independent electronic components. For example, the components 12 to 17 may be implemented respectively by single-chip semiconductor integrated circuits. Alternatively, the entirety or part of the components 11 to 17 may be implemented in the form of an integrated electronic component. For example, the data-line driving circuit 12 and the scanning-line driving circuit 13 may be formed integrally with the display panel section 11. Alternatively, the entirety or part of the components 11 to 16 may be implemented by a programmable IC chip, the functions thereof being implemented in software by programs written to the IC chip.

Referring to FIG. 2, the display panel section 11 includes a plurality of (n×m) pixel circuits 20 arranged in n rows (n is an integer) and m columns (m is an integer), disposed in association with intersections of m data lines X1 to Xm extending along a column direction and n scanning lines Y1 to Yn extending along a row direction. Each of the pixel circuits 20 corresponds to a unit circuit or an electronic circuit. In FIG. 2, only data lines X1 to X9 among the data lines X1 to Xm and only scanning lines Y1 to Y9 among the scanning lines Y1 to Yn are shown. Each of the pixel circuits 20 includes an organic EL element 21 as an electro-optical element or light-emitting element. The organic EL element 21 is a light-emitting element that emits light when a driving current is supplied thereto.

The pixel circuits 20 include three types of pixel circuits 20R, 20G, and 20B for red, green, and blue, respectively. The pixel circuits 20R for red, the pixel circuits 20G for green, and the pixel circuits 20B for blue include organic EL elements 21 that emit red light, green light, and blue light, respectively, from light-emitting layers composed of organic materials. Each set of a pixel circuit 20R for red, a pixel circuit 20G for green, and a pixel circuit 20B for blue constitutes a pixel.

Furthermore, as shown in FIG. 2, to each of the scanning lines Y1 to Yn, pixel circuits 20 for the same color are connected. For example, in this embodiment, m pixel circuits 20R for red are connected to each of the scanning lines Y1, Y4, Y7, Y10, and so forth, m pixel circuits 20G for green are connected to each of the scanning lines Y2, Y5, Y8, Y11, and so forth, and m pixel circuits 20B for blue are connected to each of the scanning lines Y3, Y6, Y9, Y12, and so forth.

When one of the scanning lines Y1, Y4, Y7, Y10, and so forth is selected, multi-valued red-data signals IDR are supplied to the selected scanning line via the data lines X1 to Xm. When one of the scanning lines Y2, Y5, Y8, Y11, and so forth is selected, multi-valued green-data signals IDG are supplied to the selected scanning line via the data lines X1 to Xm. When one of the scanning lines Y3, Y6, Y9, Y12, and so forth is selected, multi-valued blue-data signals are supplied to the selected scanning line via the data lines X1 to Xm. Transistors provided in the pixel circuits 20R, 20G, and 20B are usually implemented by thin-film transistors (TFTs).

Referring to FIG. 3, each of the pixel circuits 20R, 20G, and 20B includes a driving transistor Qd as a first transistor, having a drain (a first terminal) and a source (a second terminal), and a hold capacitor C1 as a capacitor, connected to a gate of the driving transistor Qd (a first control terminal). Furthermore, each of the pixel circuits 20R, 20G, and 20B includes a second switching transistor Qsw2 as a second transistor, having a source (a third terminal) and a drain (a fourth terminal), for controlling electrical connection between the drain of the driving transistor Qd and the hold capacitor C1.

Furthermore, each of the pixel circuits 20R, 20G, and 20B includes a first switching transistor Qsw1 as a third transistor, having a drain (a fifth terminal) and a source (a sixth terminal), a starting transistor Qst, and an organic EL element 21.

The driving transistor Qd can be implemented by a P-channel FET. The first and second switching transistors Qsw1 and Qsw2 and the starting transistor Qst can be respectively implemented by N-channel FETs.

The drain of the driving transistor Qd is connected to an anode of the organic EL element 21 via the starting transistor Qst, and the source of the driving transistor Qd is connected to a power-supply line L1. That is, the source of the driving transistor Qd (the second terminal) is electrically connected to a power-supply voltage Vdd at a predetermined potential. The cathode of the organic EL element 21 is grounded. To the power-supply line L1, the power-supply voltage Vdd for driving the organic EL element 21 is supplied. The hold capacitor C1 as a capacitor is connected between the gate of the driving transistor Qd and the power-supply line L1.

The gate of the driving transistor Qd is connected to the drain of the second switching transistor Qsw2. The source of the second switching transistor Qsw2 is connected to the drain of the first switching transistor Qsw1. The drain of the first switching transistor Qsw1 is connected to the drain of the driving transistor Qd. The source of the first switching transistor Qsw1 is connected to the data line Xm.

The scanning lines Y1 to Yn respectively include first subscanning lines Y11 to Yn1, second subscanning lines Y12 to Yn2, and third subscanning lines Y13 to Yn3.

In FIG. 3, only the scanning line Yn and three subscanning lines Yn1, Yn2, and Yn3 constituting the scanning line Yn are shown. The gate of the first switching transistor Qsw1 (a third control terminal) is connected to the associated one of the first subscanning lines Y11 to Yn1 of the scanning lines Y1 to Yn. The gate of the second switching transistor Qsw2 (a second control terminal) is connected to the associated one of the second subscanning lines Y12 to Yn2 of the scanning lines Y1 to Yn. In FIG. 3, the gate of the first switching transistor Qsw 1 is connected to the first subscanning line Yn 1, and the gate of the second switching transistor Qsw2 is connected to the second subscanning line Yn2.

When one of the scanning lines Y1 to Yn, for example, the scanning line Yn, is selected, the first switching transistor Qsw1 and the second switching transistor Qsw2 are turned on by a first scanning signal SCn1 at H level (high level) and a second scanning signal SCn2 at H level, supplied via the first subscanning line Yn1 and the second subscanning line Yn2, respectively.

Furthermore, the gate of the starting transistor Qst is connected to the associated one of the third subscanning lines Y13 to Yn3 (the subscanning line Yn3 in FIG. 3) of the scanning lines Y1 to Yn (the scanning line Yn in FIG. 3). The starting transistor Qst is turned on by a third scanning signal SCn3 at H level, output from the third subscanning line Yn3.

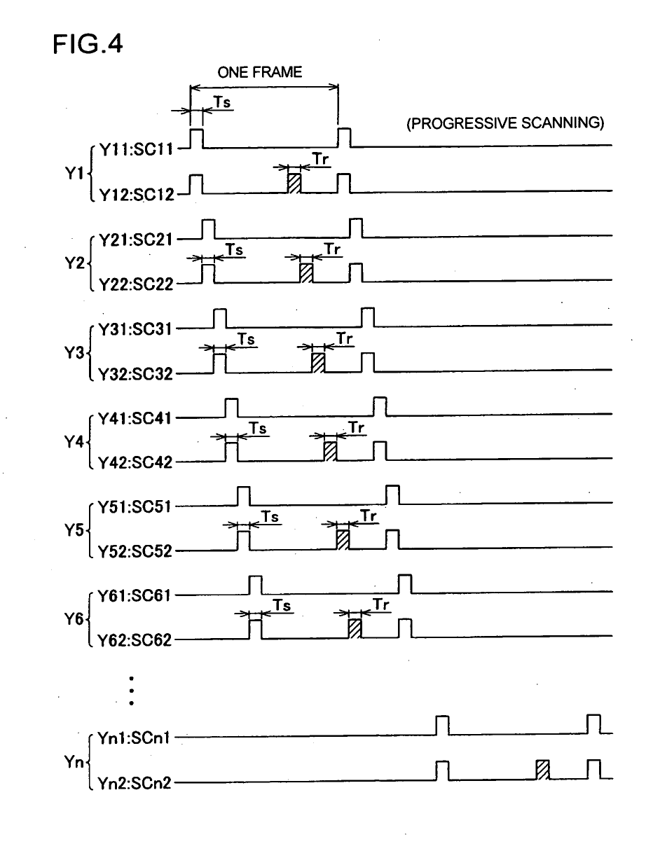

Now, the operation of the pixel circuits 20 (20R, 20G, and 20B) configured as described above will be described briefly. Since the pixel circuits 20R, 20G, and 20B operate in the same manner, as an example of the operations of the pixel circuits 20 in a case where one of the scanning lines Y1 to Yn is selected, the operations of the pixel circuits 20R in a case where the scanning line Y1 is selected will be described with reference to FIGS. 3 and 4.

When the scanning line Y1 is selected, in a set period Ts shown in FIG. 4, a first scanning signal SC11 at H level and a second scanning signal SC12 at H level are input to the gates of the transistors Qsw1 and Qsw2 of each of the pixel circuits 20R for red via the first subscanning line Y11 and the second subscanning line Y12. Thus, the transistors Qsw1 and Qsw2 are both turned on. Then, a red-data signal IDR is supplied to each of the pixel circuit 20R for red via the data line Xm, whereby an amount of charge corresponding to the red-data signal IDR is held by the hold capacitor C1. Thus, a voltage corresponding to a luminance level that is set according to the value of current of the red-data signal IDR is applied to the gate of the driving transistor Qd.

Then, the first scanning signal SC11 and the second scanning signal SC12 change from H level to L level (low level), and a third scanning signal SC13 changes from L level to H level. Thus, the transistors Qsw1 and Qsw2 and the starting transistor Qst are turned on, whereby the driving transistor Qd enters a conduction state in accordance with a gate voltage that is set according to an amount of charge held by the hold capacitor C1. Then, a driving current in accordance with the conduction state, i.e., a driving current in accordance with the value of current of the red-data signal IDR, flows through the organic EL element 21, whereby the organic EL element 21 starts and continues emitting light at a luminance level in accordance with the driving current.

As described above, when the scanning line Y1 is selected, in each of the pixel circuits 20R for red connected to the scanning line Y1, during the set period Ts shown in FIG. 4, the driving transistor Qd is turned on, whereby the organic EL element 21 is caused to emit light at a luminance level that is set according to the value of current of the red-data signal IDR. In the following description, an operation in which the driving transistor Qd of a pixel circuit 20 is turned on to start emission of light by an organic EL element 21 will be referred to as a set operation.

Then, in a reset period Tr shown in FIG. 4, the first switching transistor Qsw1 of each of the pixel circuits 20R for red connected to the scanning line Y1 is kept turned off, and the second switching transistor Qsw2 is turned on. That is, the first scanning signal SC11 and the second scanning signal SC12 are maintained at L level after the set period Ts, and in the reset period Tr, only the second scanning signal SC12 is changed from L level to H level. Thus, the power-supply voltage Vdd at the predetermined potential is electrically connected to the hold capacitor C1 via the driving transistor Qd and the second switching transistor Qsw2. Accordingly, the hold capacitor C1 of each of the pixel circuits 20R for red, by which the amount of charge has been held, is reset to a reset voltage at or above Vdd-Vth (Vth denotes a threshold voltage of the driving transistor Qd). Thus, the driving transistor Qd is turned off, inhibiting supply of a current to the organic EL element 21, whereby the organic EL element 21 stops emitting light. In the following description, an operation in which the amount of charge held by the hold capacitor C1 of a pixel circuit 20 is reset to the reset voltage to stop emission of light by an organic EL element 21 will be referred to as a reset operation or reset.

The organic EL element 21 of each of the pixel circuits 20R, having been reset as described above, is maintained so as not to emit light before the set operation described above is executed in the set period Ts of the next frame. That is, the pixel of the pixel circuit 20R for red does not emit light (i.e., it is dark in the case of normally black), and the hold capacitor C1 of each of the pixel circuits 20R for red is maintained reset to the amount of charge of the reset voltage and waits for the next set period Ts to start.

At this time, the starting transistor Qst of each of the pixel circuits 20R for red may be turned on, or turned off so that the organic EL element 21 will be adequately inhibited from emitting light.

The operation of the pixel circuits 20R for red in a case where the scanning line Y1 is selected, described above, also applies to the operations of the pixel circuits 20R for red, the pixel circuits 20G for green, and the pixel circuits 20B for blue in cases where the other scanning lines Y2 to Yn are selected.

As described above, the method of driving the pixel circuits 20 according to this embodiment includes a first step and a second step described below.

(First Step) The transistors Qsw1 and Qsw2 are both turned on. In that state, a data signal IDR supplied via one of the data lines X1 to Xm serving as third signal lines is supplied to the hold capacitor C1 via the source and drain of the first switching transistor Qsw1, whereby a corresponding charge is accumulated in the hold capacitor C1. Thus, the conduction state of the driving transistor Qd is set in accordance with the data signal IDR.

(Second Step) The transistor Qsw1 is turned off and the transistor Qsw2 is turned on, thereby changing the conduction state, set in the first step, of the driving transistor Qd. In this embodiment, the driving transistor Qd is turned off. Instead of turning off the driving transistor Qd, an amount of charge that causes reduction in the conduction state, set in the first step, of the driving transistor Qd may be supplied to the hold capacitor C1. The reduction in the conduction state of the driving transistor Qd herein refers to reducing the conductivity of the driving transistor Qd by changing the voltage applied to the gate thereof toward the reset voltage (Vdd-Vth).

Referring to FIG. 2, the data-line driving circuit 12 includes single-line driving circuits 30 respectively for the data lines X1 to Xm. The single-line driving circuits 30 supply data signals IDR, IDG, and IDB for red, green, and blue to the pixel circuits 20R, 20G, and 20B for red, green, and blue via the data lines X1 to Xm. The internal states (the amounts of charge held by the hold capacitors C1) of the pixel circuits 20R, 20G, and 20B for red, green, and blue are set according to the data signals IDR, IDG, and IDB, and the values of currents that flow through the organic EL elements 21 are controlled accordingly.

Each of the single-line driving circuits 30 includes a data-current generating circuit 30a. When one of the scanning lines Y1 to Yn is selected, the data-current generating circuit 30a supplies one of data signals IDR, IDG, and IDB for red, green, and blue, associated with the selected scanning line, via one of the data lines X1 to Xm. For example, when the scanning line Y1 is selected, a data signal IDR for red is supplied via the data line X1. Each of the data signals IDR, IDG, and IDB for red, green, and blue, generated by the data-current generating circuits 30a of the single-line driving circuits 30, is multi-valued data, and in this embodiment, it takes on one of 64 values of current.

The scanning-line driving circuit 13 performs vertical scanning in which the n rows of scanning lines Y1 to Yn are sequentially selected one by one, at least twice in one frame period.

During the first time of vertical scanning, the n rows of scanning lines Y1 to Yn are sequentially selected one by one, and the set operation described earlier is executed in each set period Ts shown in FIG. 4. More specifically, the transistors Qsw1 and Qsw2 of each of the pixel circuits 20 connected to the selected scanning line (pixel circuits on one row), among the n×m pixel circuits 20 (20R, 20G, and 20B), are turned on, whereby the conduction state of the driving transistor Qd is set according to a data signal. Accordingly, the organic EL elements 21 of the n rows of pixel circuits 20 connected to the n rows of scanning lines Y1 to Yn are caused to emit light sequentially on a row-by-row basis. Selecting the n rows of scanning lines Y1 to Yn sequentially one by one refers to sequentially selecting the first subscanning line Y11 and the second subscanning line Y12, the first subscanning line Y21 and the second subscanning line Y22, . . . , and the first subscanning line Yn1 and the second subscanning line Yn2. To first and second subscanning lines selected, for example, to the first subscanning line Y11 and the second subscanning line Y12, a first scanning signal SC11 at H level and a second scanning signal SC12 at H level are supplied, respectively, whereby the first switching transistor Qsw1 and the second switching transistor Qsw2 are both turned on.

During the second time of vertical scanning, the n rows of scanning lines Y1 to Yn are selected sequentially one by one (herein, the second subscanning lines Y12 to Yn2 are sequentially selected one by one), and the reset operation described earlier is executed in each reset period Tr shown in FIG. 4. More specifically, among the n×m pixel circuits 20 (20R, 20G, and 20B), the transistors QSw1 and Qsw2 of each pixel circuit 20 connected to a selected scanning line (pixel circuits on one row) are turned off and turned on, respectively, and the driving transistor Qd is turned off.

Accordingly, the organic EL elements 21 of the n rows of pixel circuits 20 connected to the n rows of scanning lines Y1 to Yn stop emitting light sequentially on a row-by-row basis. Sequentially selecting the n rows of scanning lines Y1 to Yn one by one refers to sequentially selecting the first subscanning line Y11 and the second subscanning line Y12, the first subscanning line Y21 and the second subscanning line Y22, . . . , and the first subscanning line Yn1 and the second subscanning line Yn2. A first scanning signal SC 1 that is supplied to a first subscanning line selected, e.g., the first subscanning line Y11, is maintained at L level. To a second subscanning line selected, e.g., the second subscanning line Y12, a second scanning signal SC12 at H level is supplied. Accordingly, the first switching transistor Qsw1 is turned off and the second switching transistor Qsw2 is turned on.

The memory circuit 14 stores image data supplied from a computer 18. The oscillation circuit 15 supplies a reference signal for operation to the other components of the organic EL display 10. The power-supply circuit 16 supplies a power for driving the components of the organic EL display 10.

The control circuit 17 integrally controls the display panel section 11 and the circuits 12 to 16. The control circuit 17 converts image data representing display status of the display panel section 11, stored in the memory circuit 14, into matrix data representing luminance levels of light emission by the organic EL elements 21. The matrix data includes a scanning-line control signal CTS for specifying the scanning lines Y1 to Yn through which first scanning signals SC 1 to SCn1 and second scanning signals SC12 to SCn2 are output, thereby selecting one row of pixel circuits. Furthermore, the matrix data includes a data-line control signal CTD for determining data signals IDR, IDG, and IDB for red, green, and blue for setting the luminance levels of the organic EL elements 21 of a group of pixel circuits that is selected on a row-by-row basis. The scanning-line control signal CTS is supplied to the scanning-line driving circuit 13, and the data-line control signal CTD is supplied to the data-line driving circuit 12.

The control circuit 17 performs the operation for selecting the scanning lines Y1 to Yn twice as described above, controlling the data-line driving circuit 12 and the scanning-line driving circuit 13 so that an image of one frame will be formed.

Next, a method of driving the organic EL display 10 by the control circuit 17 will be described with reference to FIG. 4. FIG. 4 is a timing chart of the first scanning signals SC11 to SCn1 and the second scanning signals SC12 to SCn2 output to the first subscanning lines Y11 to Yn1 and the second subscanning lines Y12 to Yn2 of the scanning lines Y1 to Yn.

When a frame period is started by a vertical-scanning start signal, the first time of vertical scanning starts. During the first time of vertical scanning, as described earlier, the conduction state of the driving transistor Qd of each pixel circuit 20 on one row connected to a selected scanning line, among the n×m pixel circuits 20 (20R, 20G, and 20B), is set according to a data signal (the set operation described earlier is executed). Accordingly, the organic EL elements 21 of the n rows of pixel circuits 20 connected to the n rows of scanning lines Y1 to Yn are caused to emit light sequentially on a row-by-row basis.

Then, the second time of vertical scanning is performed. During the second time of vertical scanning, as described earlier, the driving transistors Qd of pixel circuits 20 on one row connected to the selected scanning line, among the n×m pixel circuits 20 (20R, 20G, and 20B), are sequentially turned off. Accordingly, the organic EL elements 21 of the n rows of pixel circuits 20 connected to the n rows of scanning lines Y1 to Yn stop emission of light sequentially on a row-by-row basis (the reset operation described earlier is executed). In this manner, an image of one frame is formed.

As described above, progressive vertical scanning is performed twice in one frame period. By the first time of vertical scanning, the conduction states of the driving transistors Qd of pixel circuits 20 of one row connected to the n rows of scanning lines Y1 to Yn are sequentially set. Accordingly, the organic EL elements 21 of the n rows of pixel circuits 20 connected to the n rows of scanning lines Y1 to Yn are caused to emit light sequentially on a row-by-row basis, whereby an image of one frame is formed.

Next, features of the method of driving the organic EL display 10 according to the first embodiment will be described below.

(1) In the set periods Ts shown in FIG. 4, the conduction states of the driving transistors Qd of the pixel circuits 20 (20R, 20G, and 20B) are set according to data signals, so that the organic EL elements 21 of the pixel circuits 20 are caused to emit light at luminance levels that are set according to the values of currents of the data signals (IDR, IDG, and IDB).

In the electro-optical apparatus, the potential difference between the source and gate of the driving transistor Qd is set in advance to a threshold voltage thereof, and a voltage in accordance with a data current that is supplied from a data-signal output circuit based on a luminance level is applied to the gate of the driving transistor Qd. This method is advantageous in that variation in characteristics of the driving transistors Qd, such as threshold voltages thereof, are corrected so that the organic EL elements will be driven by driving currents having values corresponding to the values of data currents.

(2) After light emission by the organic EL element 21 of each of the pixel circuits 20 is started, in a reset period Tr shown in FIG. 4, the second switching transistor Qsw2 is turned on, whereby the power-supply voltage Vdd is electrically connected to the hold capacitor C1 via the driving transistor Qd and the second switching transistor Qsw2. Thus, the hold capacitor C1 is reset to a reset voltage at or above Vdd-Vth, and the driving transistor Qd is turned off, whereby supply of a current to the organic EL element 21 is inhibited. Thus, light emission by the organic EL element 21 is stopped in a short period.

(3) With the driving transistor Qd turned off and light emission by the organic EL element 21 stopped, a charge corresponding to a data signal, i.e., a data current, is written to the hold capacitor C1 when constructing a next frame.

Since the hold capacitor C1 has already been charged by the reset voltage at or above Vdd-Vth, the effect of wire capacitance of the data line Xn is suppressed. Thus, in the set operation, the hold capacitor C1 reaches an amount of charge to be held (data value) in a short period. Accordingly, the organic EL element 21 is caused to emit light at a specified luminance level in a short period. Therefore, even when the value of a data current is small, for example, when the luminance level is low, the data current is written in a short period. Thus, the effect of wire capacitance of the data lines, etc. is suppressed. Accordingly, when a moving picture is displayed, occurrence of a pseudo contour or deviation of an image is suppressed, serving to improve moving-picture characteristics.

(4) The driving transistor Qd can be turned off simply by controlling on/off of the first switching transistor Qsw1 and the second switching transistor Qsw2, without providing a transistor or circuit particularly for that purpose. Thus, without additionally providing a voltage generating circuit for generating a reset voltage or a transistor for applying a reset voltage to the hold capacitor C1, even data corresponding to a low luminance level can be written in a short period, serving to reduce delay of operation. That is, compared with a case where an entire frame period constitutes a light emitting period, the level of a current to be written is set relatively high, serving to suppress the effect of stray capacitance.

(5) Since the light emitting period of the organic EL element 21 of each of the pixel circuits 20 is shortened, power consumption is reduced compared with the related art in which the organic EL element 21 continues emitting light until a next frame starts.

(6) Since time for writing data is reduced, data can be written quickly.

(7) As shown in FIG. 2, each of the scanning lines Y1 to Yn is connected to pixel circuits 20 for the same color. Thus, the light emitting periods of the organic EL elements 21 can be varied as desired on a color-by-color basis by varying timing for stopping light emission by the organic EL elements 21 for each of the scanning lines Y1 to Yn. Accordingly, change in color balance due to change over time, etc. can be readily adjusted.

The organic EL element 21 of each of the pixel circuits 20, having been reset, is maintained so as not to emit light until a next set operation is executed in a set period Ts of a next frame. In other words, the pixel of each of the pixel circuits 20 remains dark, and the hold capacitor C1 remains reset at the amount of charge corresponding to the reset voltage and waits for the next set period Ts to start. The organic EL element 21 of each of the pixel circuits 20, having been reset, is maintained so as not to emit light until a next set operation in a set period Ts of a next frame. That is, the pixel of the pixel circuit 20R for red remains dark, and upon a set operation in the next set period Ts, the pixel displays an image instead of being dark. Thus, impulse display is allowed, so that the organic EL display 10 is suitable for displaying moving pictures.

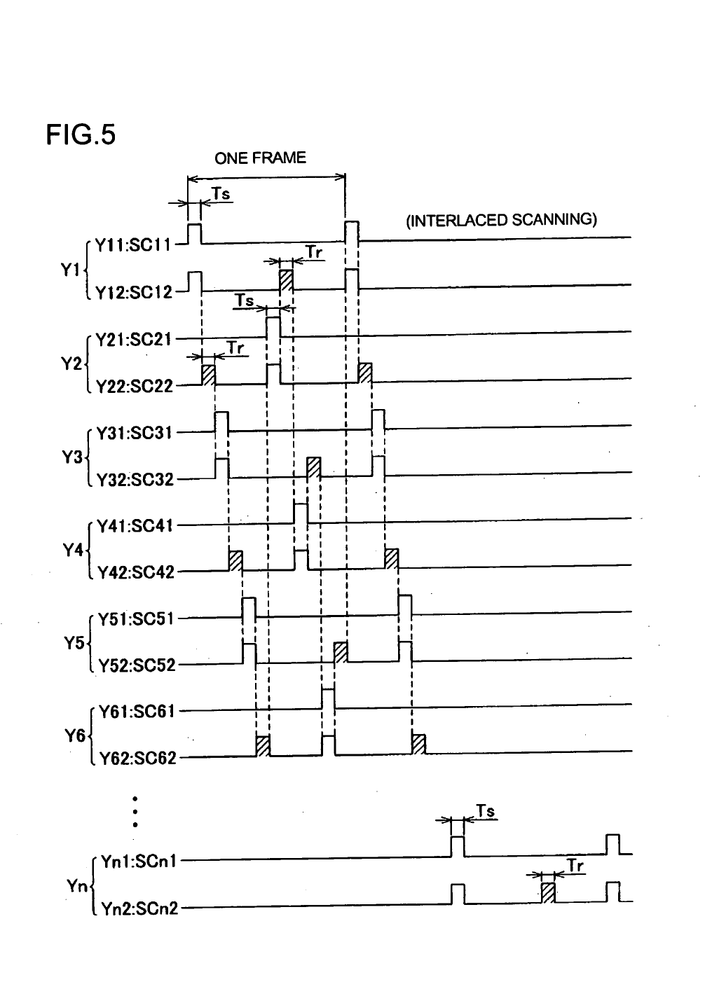

Next, a method of driving the organic EL display 10 according to a second embodiment will be described with reference to FIG. 5. As opposed to the first embodiment described above, in which progressive vertical scanning is performed twice in one frame period to form an image of one frame, in this embodiment, interlaced vertical scanning is performed to form an image of one frame. FIG. 5 is a timing chart similar to FIG. 4.

A method of driving the organic EL display 10 by the control circuit 17 will be described with reference to FIG. 5.

When a frame period is started by a vertical-scanning start signal, vertical scanning in which the n rows of scanning lines Y1 to Yn are sequentially selected one by one is performed twice in the frame period.

During the first time of vertical scanning, the set operation described earlier is executed when the scanning lines Y1, Y3, Y5, . . . , and Yn−1 on odd-numbered rows among the n rows of scanning lines Y1 to Yn are selected. That is, similarly to the first time of vertical scanning described with reference to FIG. 4, the conduction state of the driving transistor Qd of each of pixel circuits 20 on one row connected to a selected scanning line, among the plurality of pixel circuits 20, is set according to a data signal. Thus, the organic EL elements 21 of the pixel circuits 20 connected to the selected scanning line start emitting light. Furthermore, the reset operation described earlier is executed when the scanning lines Y2, Y4, Y6, . . . , Yn−2, and Yn on even-numbered rows are selected. That is, similarly to the second time of vertical scanning described with reference to FIG. 4, the second switching transistor Qsw2 of each pixel circuit 20 on one row connected to a selected scanning line, among the plurality of pixel circuits 20, is turned on. Accordingly, the driving transistors Qd that have been turned on are now turned off, whereby the organic EL elements 21 of the pixel circuits 20 connected to the selected scanning line stop emitting light.

During the second time of vertical scanning, the reset operation described earlier is executed when the scanning lines Y1, Y3, Y5, . . . , and Yn−1 on the odd-numbered rows among the n rows of scanning lines Y1 to Yn are selected. Thus, the driving transistor Qd of each pixel circuit 20 on one row, having been turned on during the first time of vertical scanning, is turned off, whereby the organic EL element 21 stops emitting light. Furthermore, the set operation described earlier is executed when the scanning lines Y2, Y4, Y6, . . . , Yn−2, and Yn on the even-numbered rows are selected. Thus, the conduction state of the driving transistor Qd of each of the pixel circuits 20 on one row connected to the selected scanning line is set according to a data signal, whereby the organic EL element 21 of each of the pixel circuits 20 starts emitting light.

As described above, during the first time of vertical scanning, the n rows of scanning lines Y1 to Yn are sequentially selected one by one, the set operation described earlier is executed when the scanning lines on the odd-numbered rows are selected, and the reset operation described earlier is executed when the scanning lines on the even-numbered rows are selected. In the subsequent second time of vertical scanning, conversely to the first time, the reset operation is executed when the scanning lines on the odd-numbered rows are selected, and the set operation is executed when scanning lines on the even-numbered rows are selected. By performing vertical scanning twice in one frame period as described above, each of the n rows of scanning lines Y1 to Yn is selected twice, once for a set operation and once for a reset operation.

In addition to the advantages of the method of driving an organic EL display according to the first embodiment, the method of driving an organic EL display according to the second embodiment has an advantage described below.

(9) Since an image of one frame is formed by interlaced vertical scanning as described above, the set periods TS in which the scanning lines Y1 to Yn are selected for the set operation are distributed instead of being concentrated, so that loads on circuits such as the data-line driving circuit 12 and the scanning-line driving circuit 13 are reduced. Furthermore, since the reset periods Tr in which the scanning lines Y1 to Yn are selected for the reset operation are also distributed instead of being concentrated, loads on circuits such as the data-line driving circuit 12 and the scanning-line driving circuit 13 are reduced.

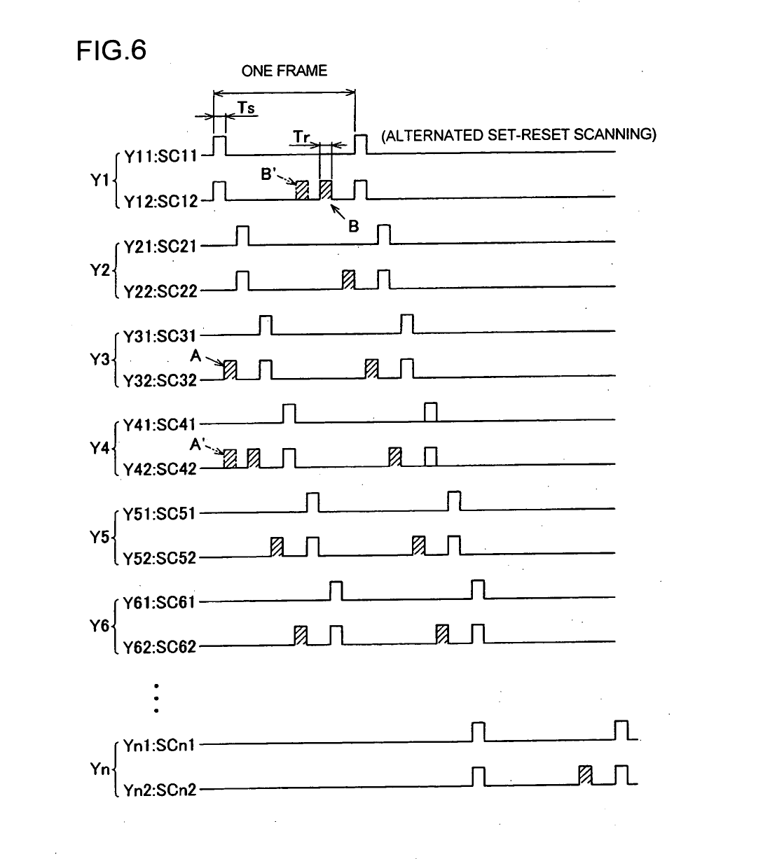

Next, a method of driving an organic EL display according to a third embodiment will be described with reference to FIG. 6. In this embodiment, an image of one frame is formed by alternated set-reset vertical scanning. FIG. 6 is a timing chart similar to FIG. 4.

A method of driving the organic EL display 10 by the control circuit 17 will be described with reference to FIG. 6.

When a frame period is started by a vertical-scanning start signal, during the frame period, the set operation and the reset operation are executed alternately each time one of the scanning lines Y1 to Yn is selected. That is, the set operation of setting the conduction state of the driving transistor Qd of each of pixel circuits 20 on one row according to a data signal and the reset operation of turning off the second switching transistor Qsw2 of each of pixel circuits 20 on one row to reset the organic EL element 21 are executed alternately each time a scanning line is selected. Scanning lines on which the set operation is executed and scanning lines on which the reset operation is executed are each selected sequentially from the plurality of scanning lines Y1 to Yn.

More specifically, in this embodiment, upon the start of a frame period, the plurality of scanning lines Y1 to Yn are sequentially selected one by one in the order described below, and the set operation and the reset operation are executed alternately each time a scanning line is selected. The order of one cycle of selection is as follows: Y1(s), Y3(r), Y2(s), Y4(r), Y3(s), Y5(r), Y4(s), Y6(r), Y5(s), Y7 (not shown, (r)), Y6(s), . . . , Yn−1(s), Y1(r), Yn(s), Y2(r). The variables s and r herein refer to the set operation and the reset operation, respectively. In the single cycle, each of the scanning lines Y1 to Yn is selected twice.

As described above, the set operation and the reset operation are executed alternately each time a scanning line is selected. Scanning lines on which the set operation is executed are selected sequentially in order of the scanning lines Y1 to Yn, and scanning lines on which the reset operation is executed are selected sequentially in order of the scanning lines Y3 to Yn, then Y1, and Y2.

Next, features of the method of driving the organic EL display 10 according to the third embodiment will be described below.

(10) Since an image of one frame is formed by the alternated set-reset vertical scanning as described above, set periods Ts in which the scanning lines Y1 to Yn are selected for the set operation are distributed instead of being concentrated, so that loads on circuits including the data-line driving circuit 12 and the scanning-line driving circuit 13 are reduced. Furthermore, since reset periods Tr in which the scanning lines Y1 to Yn are selected for the reset operation are also distributed instead of being concentrated, loads on circuits including the data-line driving circuit 12 and the scanning-line driving circuit 13 are reduced.

(11) In this embodiment, after the scanning line Y1 on the first row is selected, the scanning line Y3 on the third row is selected as a scanning line on which the reset operation is first executed. That is, the scanning line Y3 is selected for the reset operation at a timing indicated by “A” in FIG. 6. When a scanning line on a lower row is chosen as a scanning line on which the reset operation is first executed, a light-emitting period of the organic EL element 21 of each of the pixel circuits 20 becomes shorter. For example, if the scanning line that is first reset is changed to the scanning line Y4 on the fourth row as indicated by “A′” in FIG. 6, the reset period Tr in which the reset operation is executed on the scanning line Y1 on the first row is shifted from a timing indicated by “B” to a timing indicated by “B′”, so that the light-emitting period becomes shorter. The “light-emitting period” herein refers to a period from a start to an end of light emission by the organic EL element 21 of a pixel circuit 20.

Thus, the light-emitting period can be changed by appropriately selecting a scanning line on which the reset operation is first executed.

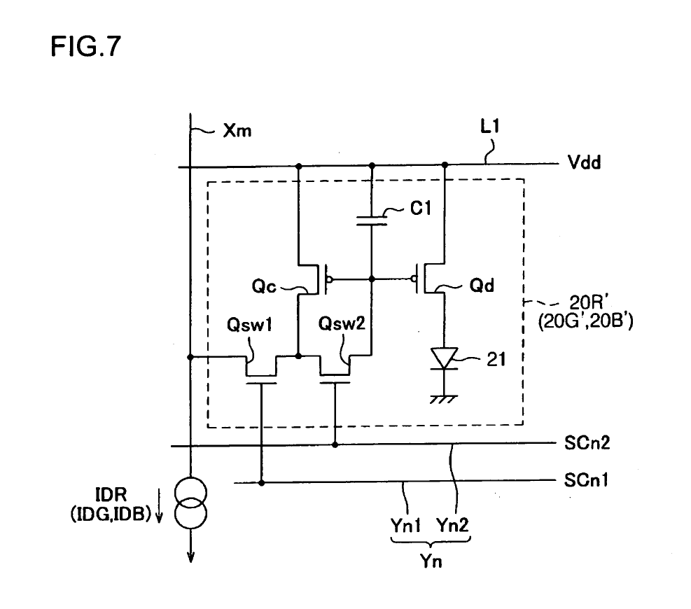

Next, a fourth embodiment in which a method of driving an electronic apparatus or an electro-optical apparatus according to the present invention is applied to an organic EL display will be described with reference to FIG. 7. FIG. 7 is an exemplary circuit diagram showing the internal circuit configuration of a pixel circuit in an organic EL display 10 described in the first embodiment.

In this embodiment, the present invention is applied to an organic EL display 10 including pixel circuits 20′R, 20′G, and 20′B shown in FIG. 7 instead of the pixel circuits 20R, 20G, and 20B shown in FIG. 3. The other components are the same as the corresponding components in the first embodiment. Thus, the same components as in the first embodiment are designated by the same numerals, and repeated descriptions thereof will be omitted.

Referring to FIG. 7, each of the pixel circuits 20′R, 20′G, and 20′B includes a driving transistor Qd as a first transistor, having a drain (a first terminal) and a source (a second terminal), and a converting transistor Qc as a second transistor. The converting transistor Qc has a gate (a second control terminal) connected to a gate of the driving transistor Qd (a first control terminal), a drain (a third terminal), and a source (a fourth terminal).

Furthermore, each of the pixel circuits 20′R, 20′G, and 20′B includes a hold capacitor C1 commonly connected to the gate of the driving transistor Qd and the gate of the converting transistor Qc, and a second switching transistor Qsw2 as a third transistor. The second switching transistor Qsw2 controls electrical connection between the drain and gate of the converting transistor Qc, and it has a drain (a fifth terminal) and a source (a sixth terminal).

Furthermore, each of the pixel circuits 20′R, 20′G, and 20′B includes a first switching transistor Qsw1 as a fourth transistor, having a drain (a seventh terminal) and a source (an eighth terminal).

Now, the operation of the pixel circuits 20′R, 20′G, and 20′B will be described briefly. Similarly to the case described earlier with reference to FIG. 3, only the operation of pixel circuits 20′R for red in a case where one of the scanning lines Y1 to Yn, e.g., the scanning line Y1, is selected will be described with reference to FIG. 7.

When the scanning line Y1 is selected, in a set period Ts (refer to FIG. 4), a first scanning signal SC11 at H level and a second scanning signal SC12 at H level are input to the gates of the transistors Qsw1 and Qsw2 of each of the pixel circuits 20′R for red via the first subscanning line Y11 and the second subscanning line Y12, respectively. Accordingly, the transistors Qsw1 and Qsw2 are turned on. At this time, a data signal IDR for red is supplied to each of the pixel circuits 20′R for red via the data line Xm, whereby an amount of charge corresponding to the data signal IDR for red is held by the hold capacitor C1. Thus, a voltage in accordance with a luminance level that is set according to the value of current of the data signal IDR for red is applied to the gate of the driving transistor Qd.

Then, the first scanning signal SC11 and the second scanning signal SC12 change from H level to L level. Accordingly, the transistors Qsw1 and Qsw2 are both turned on, whereby the driving transistor Qd enters a conduction state in accordance with a gate voltage that is set according to an amount of charge held by the hold capacitor C1. At this time, a driving current in accordance with the conduction state, i.e., a driving current in accordance with the value of current of the data signal IDR for red, flows through the organic EL element 21. Thus, the organic EL element 21 starts and then continues emitting light at a luminance level corresponding to the driving current.

As described above, when the scanning line Y1 is selected, in each of the pixel circuits 20′R for red, connected to the scanning line Y1, in a set period Ts, the conduction states of the converting transistor Qc and the driving transistor Qd are set according to a data signal IDR for red, and the organic EL element 21 is caused to emit light at a luminance level that is set according to the value of current of the signal (i.e., a set operation is executed).

Then, with the first switching transistor Qsw1 kept turned off, in a reset period Tr (refer to FIG. 4), the second scanning signal SC12 is changed from L level to H level, whereby the second switching transistor Qsw2 is turned on. Accordingly, the hold capacitor C1 is electrically connected to the power-supply voltage Vdd via the driving transistor Qd and the second switching transistor Qsw2. Thus, the hold capacitor C1 of each of the pixel circuits 20′R for red, in which the amount of charge has been held, is reset to a reset voltage of Vdd-Vth or above. Accordingly, the driving transistor Qd is turned off to inhibit supply of a current to the organic EL element 21, whereby the organic EL element 21 stops emitting light (i.e., a reset operation is executed).

The organic EL element 21 of each of the pixel circuits 20′R for red, having been reset as described above, is maintained so as not to emit light until a set operation is executed in the set period Ts of the next frame. That is, the pixel of each of the pixel circuits 20′R for red does not emit light (it is dark in the case of normally black), and the hold capacitor C1 of each of the pixel circuits 20′R for red remains reset to the amount of charge of the reset voltage and waits for the next set period Ts to start.

The operation of the pixel circuits 20′R for red in the case where the scanning line Y1 is selected, described above, also applies similarly to operations of the pixel circuits 20′R for red, the pixel circuits 20′G for green, the pixel circuits 20′B for blue in cases where the other scanning lines Y2 to Yn are selected.

As described above, the method of driving the pixel circuits 20 according to this embodiment includes a first step and a second step described below.

(First Step) The transistors Qsw1 and Qsw2 are both turned on. In this state, a data signal IDR that is supplied via one of the data lines X1 to Xm as third signal lines is supplied to the hold capacitor C1 via the source and drain of the first switching transistor Qsw1, whereby an amount of charge is accumulated in the hold capacitor C1. Thus, the conduction states of the converting transistor Qc and the driving transistor Qd are set according to the data signal IDR.

(Second Step) The first switching transistor Qsw1 is turned off and the second switching transistor Qsw2 is turned on to change the conduction states, set in the first step, of the converting transistor Qc and the driving transistor Qd. In this case, for example, the transistors Qc and Qd are both turned off. Instead of turning off both the transistors Qc and Qd, an amount of charge that causes reduction in the conduction states, set in the first step, of the transistors Qc and Qd, may be supplied to the hold capacitor C1.

Next, features of the method of driving the organic EL display 10 according to the fourth embodiment will be described below.

(12) According to this embodiment, similarly to the first embodiment, the advantages (1) to (8) described earlier are achieved. Furthermore, data can be written quickly by employing, as a driving method in this embodiment, the interlaced vertical scanning as described in relation to the second embodiment or the alternated set-reset vertical scanning as described in relation to the third embodiment.

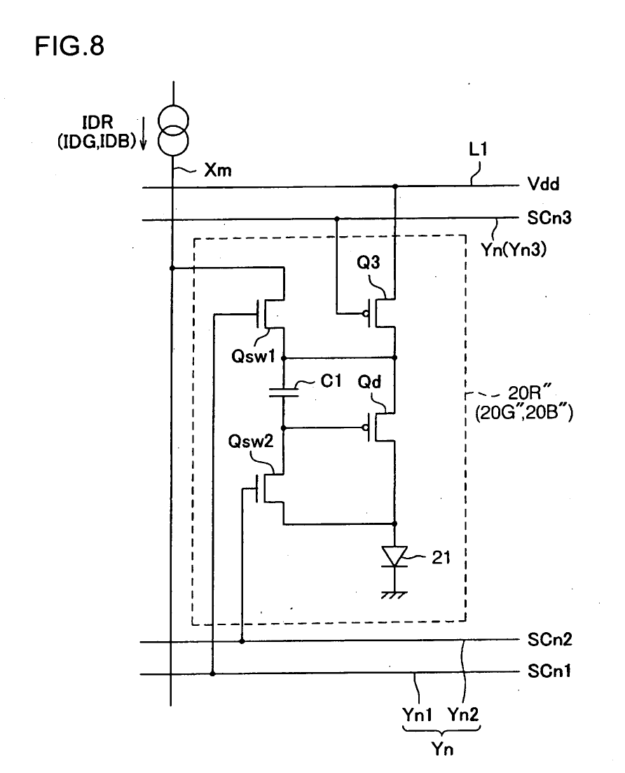

Next, a fifth embodiment in which a method of driving an electronic apparatus or an electro-optical apparatus according to the present invention is applied to an organic EL display will be described with reference to FIG. 8. FIG. 8 is an exemplary circuit diagram showing the internal circuit configuration of a pixel circuit of the organic EL display 10 described in the first embodiment.

In this embodiment, the present invention is applied to an organic EL display 10 including pixel circuits 20″R, 20″G, and 20″B shown in FIG. 8 instead of the pixel circuits 20R, 20G, and 20B shown in FIG. 3. The other components are the same as the corresponding components in the first embodiment. Thus, the same components as in the first embodiment are designated by the same numerals, and repeated descriptions thereof will be omitted.

Referring to FIG. 8, each of the pixel circuits 20R″, 20G″, and 20B″ includes a driving transistor Qd as a first transistor, a hold capacitor C1 connected to the gate of the driving transistor Qd (a first control terminal), and a second switching transistor Qsw2 as a second transistor. The second switching transistor Qsw2 controls electrical connection between the drain of the driving transistor Qd (a first terminal) and the hold capacitor C1, and it has a source (a third terminal) and a drain (a fourth terminal).

The source of the second switching transistor Qsw2 is connected to the drain of the driving transistor Qd (the first terminal), and the drain of the second switching transistor Qsw2 is connected to the gate of the driving transistor Qd. Furthermore, the gate of the second switching transistor Qsw2 (a second control terminal) is connected to one of the second subscanning lines Y12 to Yn2.

Furthermore, each of the pixel circuits 20″R, 20″G, and 20″B includes a first switching transistor Qsw1 as a third transistor, and a starting transistor Q3 as a fourth transistor. The source of the first switching transistor Qsw1 (a fifth terminal) is electrically connected to the drain of the second switching transistor Qsw2 via the hold capacitor C1, and is also electrically connected to the source of the driving transistor Qd (a second terminal). Furthermore, the drain of the first switching transistor Qsw1 (a sixth terminal) is connected to one of the data lines X1 to Xm. The gate of the first switching transistor Qsw1 (a third control terminal) is connected to one of the second subscanning lines Y12 to Yn2.

The starting transistor Q3 is implemented by a P-channel TFT, and the drain thereof (a seventh terminal) is connected to the source of the driving transistor Qd. The source of the starting transistor Q3 (an eighth terminal) is connected to the power-supply line L1, and the gate thereof is connected to one of the third subscanning lines Y13 to Yn3.

Now, the operation of the pixel circuits 20″R, 20″G, and 20″B will be described briefly. Only the operation of the pixel circuits 20″R for red in a case where the scanning line Y1 is selected will be described herein with reference to FIG. 8.

When the scanning line Y1 is selected, in a set period Ts (refer to FIG. 4), a first scanning signal SC11 at H level and a second scanning signal SC12 at H level are input to the gates of the transistors Qsw1 and Qsw2 of each of the pixel circuits 20″R for red via the first subscanning line Y11 and the second subscanning line Y12. Accordingly, the transistors Qsw1 and Qsw2 are both turned on. At this time, a data signal IDR for red is supplied to each of the pixel circuits 20″R for red via the data line Xm, whereby an amount of charge corresponding to the data signal IDR for red is held in the hold capacitor C1. Thus, a voltage in accordance with a luminance level that is set according to the value of current of the data signal IDR for red is applied to the gate of the driving transistor Qd.

Then, the first scanning signal SC11, the second scanning signal SC12 and the third scanning signal SC13 change from H level to L level (low level). Accordingly, the transistors Qsw1 and Qsw2 are turned off, and the starting transistor Q3 is turned on. Since the transistors Qsw1 and Qsw2 are turned off, the driving transistor Qd enters a conduction state in accordance with a gate voltage that is set according to the amount of charge held in the hold capacitor C1. At this time, a driving current in accordance with the conduction state, i.e., a driving current in accordance with the value of current of the data signal IDR for red, flows through the organic EL element 21, causing the organic EL element 21 to start and continue emitting light at a luminance level in accordance with the driving current.

As described above, when the scanning line Y1 is selected, in each of the pixel circuits 20″R for red connected to the scanning line Y1, in a set period Ts shown in FIG. 4, the driving transistor Qd is turned on, whereby the organic EL element 21 is caused to emit light at a luminance level that is set according to the value of current of a data signal IDR for red (i.e., a set operation is executed).

Then, with the transistors Qsw1 and Qsw2 kept turned off, the third scanning signal SC13 is changed from L level to H level in a reset period Tr (refer to FIG. 4). Accordingly, the starting transistor Q3 is turned off, inhibiting supply of a current to the organic EL element 21, whereby the organic EL element 21 stops emitting light.

The organic EL element 21 of each of the pixel circuits 20″R for red, having been reset as described above, is maintained so as not to emit light until a set operation is executed in the set period Ts of the next frame, and the hold capacitor C1 remains reset to the amount of charge of the reset voltage and waits for the next set period Ts to start.

The operation of each of the pixel circuits 20″R for red in the case where the scanning line Y1 is selected, described above, similarly applies to the operations of the pixel circuits 20″R for red, the pixel circuits 20″G for green, and the pixel circuits 20″B for blue in cases where the other scanning lines Y2 to Yn are selected.

As described above, the method of driving the pixel circuits 20 according to this embodiment includes a first step and a second step described below.

(First Step) The transistors Qsw1 and Qsw2 are both turned on. In this state, a data signal IDR supplied via one of the data lines X1 to Xm as third signal lines is supplied to the hold capacitor C1 via the drain and source of the first switching transistor Qsw1, whereby a corresponding charge is accumulated in the hold capacitor C1. Thus, the conduction state of the driving transistor Qd is set according to the data signal IDR.

(Second Step) The starting transistor Q3 is turned off, whereby the organic EL element 21 stops emitting light.

Next, features of the method of driving the organic EL display 10 according to the fifth embodiment will be described below.

(13) According to this embodiment, similarly to the first embodiment, the advantages (1) to (8) are achieved. Furthermore, data can be written quickly by employing the interlaced vertical scanning described in relation to the second embodiment or the alternated set-reset vertical scanning described in relation to the third embodiment.

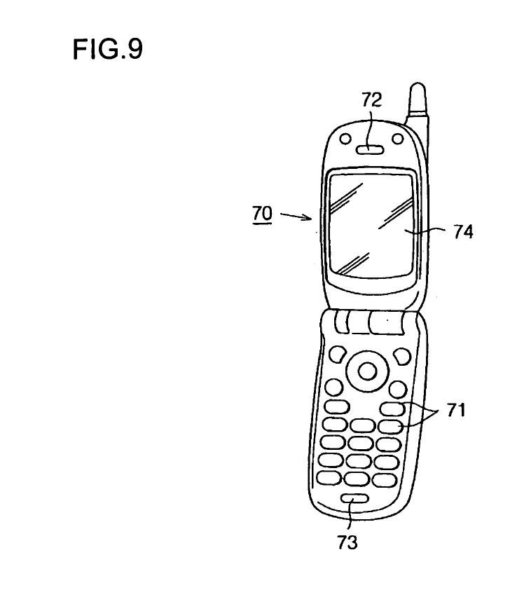

Next, application to an electronic device will be described with reference to FIG. 9. The organic EL display 10 described in relation to the embodiments described above can be applied to various electronic devices such as mobile personal computers, cellular phones, and digital cameras.

FIG. 9 shows the configuration of a cellular phone including the organic EL display 10. Referring to FIG. 9, a cellular phone 70 includes a plurality of operation buttons 71, an earpiece 72, a mouthpiece 73, and a display unit 74 including the organic EL display 10.

Also in this case, the display unit 74 including the organic EL display 10 achieves the same advantages as in the embodiments described above. Thus, the cellular phone 70 allows images to be displayed in an improved quality.

The embodiments of the present invention may be modified as described below.

Although the source of the driving transistor Qd (the second terminal) is electrically connected to the power-supply voltage Vdd as a predetermined potential in the embodiments described above, the predetermined potential is not limited to a power-supply voltage.

Although the driving transistor Qd is implemented by a P-channel FET in the embodiments described above, a driving transistor may be implemented by an N-channel FET. In that case, the driving transistor is turned off when a voltage applied to the gate of the driving transistor is at Vdd+Vth or below (a potential different from the power-supply voltage Vdd). Accordingly, the hold capacitor C1 of each pixel circuit is reset to a reset voltage of Vdd+Vth or below.

Although favorable advantages are achieved by embodying an electronic circuit in the form of the pixel circuit 20 in the embodiments described above, an electronic circuit may be embodied in the form of an electronic circuit for driving a current-driven element, for example, a light-emitting element such as an LED, an FED, an electron emission element, or a plasma element except the organic EL element 21. Alternatively, an electronic circuit may be embodied in the form of a storage device such as a RAM.

Although a current-driven element for the pixel circuits 20R, 20G, and 20B is implemented by the organic EL element 21, a current-driven element may be implemented by an inorganic EL element.

That is, the present invention may be applied to an inorganic EL display including inorganic EL elements. Furthermore, the present invention may be applied to a liquid crystal display to improve moving-picture characteristics of the liquid crystal display.

Although the embodiments have been described in the context of the organic EL display including pixel circuits 20R, 20G, and 20B for the organic EL elements 21 for three colors, the present invention may be applied to an EL display including pixel circuits for EL elements for a single color.

While this invention has been described in conjunction with specific embodiments thereof, it is evident that many alternatives, modifications, and variations will be apparent to those skilled in the art. Accordingly, preferred embodiments of the invention as set forth herein are intended to be illustrative, not limiting. Various changes may be made without departing from the spirit and scope of the invention.

What is claimed is:

1. A method of driving an electronic circuit including a first transistor having a first terminal and a second terminal, a capacitor coupled to a first control terminal of the first transistor, a second transistor that controls the electrical connection between the first terminal and the capacitor, the second transistor having a third terminal and a fourth terminal, and a third transistor having a fifth terminal and a sixth terminal, the method comprising:
a first step of turning on the second transistor and the third transistor, supplying a signal via the sixth terminal and the fifth terminal so that a charge corresponding to the signal is accumulated in the capacitor, and setting a conduction state of the first transistor according to the signal; and
a second step of turning off the third transistor and turning on the second transistor to change the conduction state, set in the first step, of the first transistor.

2. The method of driving an electronic circuit according to claim 1,
the first transistor being turned off in the second step.

3. The method of driving an electronic circuit according to claim 1,
the second terminal of the first transistor being electrically coupled to a predetermined potential, and
a potential that is different from the predetermined potential being applied to the first control terminal in the second step.

4. The method of driving an electronic circuit according to claim 3,
the potential applied to the first control terminal in the second step being a potential obtained by subtracting a threshold voltage of the first transistor from the predetermined potential or a potential obtained by adding the threshold voltage of the first transistor to the predetermined potential.

5. The method of driving an electronic circuit according to claim 1,
an electronic element being connected to the first transistor.

6. The method of driving an electronic circuit according to claim 5,
wherein, in the second step, the first transistor is turned off by the potential applied to the first control terminal of the first transistor, which resets an operation of the electronic element.

7. The method of driving an electronic apparatus including a plurality of first signal lines, a plurality of second signal lines, a plurality of third signal lines, a power-supply line, and a plurality of unit circuits,
each of the plurality of unit circuits including a first transistor having a first terminal and a second terminal, a capacitor coupled to a first control terminal of the first transistor, a second transistor that controls electrical connection between the first terminal and the capacitor, the second transistor having a third terminal and a fourth terminal, and a third transistor having a fifth terminal and a sixth terminal;
and a second control terminal of the second transistor being coupled to one of the plurality of second signal lines, a third control terminal of the third transistor is connected to one of the plurality of first signal lines, and the sixth terminal is connected to one of the plurality of third signal lines,
the method comprising:
a first step of accumulating a signal supplied via one of the third signal lines in the capacitor as a charge while the second transistor and the third transistor are both on, and setting a conduction state of the first transistor according to the signal; and
a second step of turning off the third transistor and turning on the second transistor, and supplying an amount of charge that causes reduction in the conduction state, set in the first step, of the first transistor.

8. The method of driving an electronic apparatus according to claim 7,
the first transistor being turned off in the second step.

9. A method of driving an electronic apparatus according to claim 7,
the second terminal of the first transistor being electrically coupled to a predetermined potential,
and a potential that is different from the predetermined potential being applied to the first control terminal in the second step.

10. A method of driving an electronic apparatus according to claim 9,
the potential applied to the first control terminal in the second step being a potential obtained by subtracting a threshold voltage of the first transistor from the predetermined potential or a potential obtained by adding the threshold voltage of the first transistor to the predetermined potential.

11. A method of driving an electronic apparatus according to claim 7,
an electronic element being coupled to the first transistor.

12. A method of driving an electronic apparatus according to claim 11,
wherein, in the second step, the first transistor is turned off by the potential applied to the first control terminal of the first transistor, thereby resetting an operation of the electronic element.

13. A method of driving an electro-optical apparatus including n rows of scanning lines each including a first subscanning line and a second subscanning line, m columns of data lines, a power-supply line, and a plurality of unit circuits arranged in n rows and m columns in association with intersections of the scanning lines and the data lines,
each of the plurality of unit circuits including a first transistor having a first terminal and a second terminal, a capacitor coupled to a first control terminal of the first transistor, a second transistor that controls the electrical connection between the first terminal and the capacitor, the second transistor having a third terminal and a fourth terminal, a third transistor having a fifth terminal and a sixth terminal, and an electro-optical element connected to the first transistor;
and a second control terminal of the second transistor being coupled to the second subscanning line of one of the n rows of scanning lines, a third control terminal of the third transistor is coupled to the first subscanning line of the one of the n rows of scanning lines, and the sixth terminal is connected to one of the m columns of data lines,
the method comprising:
a first step of accumulating a data signal supplied via one of the m columns of data lines in the capacitor as a charge while the second transistor and the third transistor are both on, and setting a conduction state of the first transistor according to the data signal; and
a second step of turning off the third transistor and turning on the second transistor, and supplying an amount of charge that causes reduction in the conduction state, set in the first step, of the first transistor.

14. The method of driving an electro-optical apparatus according to claim 13,
the first transistor being turned off in the second step.

15. The method of driving an electro-optical apparatus according to claim 13,
the second terminal of the first transistor being electrically coupled to a predetermined potential,
and a potential that is different from the predetermined potential being applied to the first control terminal in the second step.

16. The method of driving an electro-optical apparatus according to claim 15,
the potential applied to the first control terminal in the second step being a potential obtained by subtracting a threshold voltage of the first transistor from the predetermined potential or a potential obtained by adding the threshold voltage of the first transistor to the predetermined potential.

17. The method of driving an electro-optical apparatus according to claim 13,
wherein, in the second step, the first transistor is turned off by the potential applied to the first control terminal, thereby stopping supply of a current to the electro-optical element.

18. The method of driving an electro-optical apparatus according to claim 13,
vertical scanning in which the n rows of scanning lines are sequentially selected one by one being performed at least twice in one frame period,
wherein, in the first time of vertical scanning, when one of a first set of scanning lines including either scanning lines on odd-numbered rows or scanning lines on even-numbered rows among the n rows of scanning lines is selected, the conduction state of the first transistor of each of the one row of unit circuits coupled to the selected scanning line, among the plurality of unit circuits, is set according to the data signal, and when one of a second set of scanning lines including either the scanning lines on the odd-numbered rows or the scanning lines on the even-numbered rows, not included in the first set, is selected, the second transistor of each of the one row of unit circuits coupled to the selected scanning line is turned on to turn off the first transistor,
and wherein, in the second time of vertical scanning, when one of the second set of scanning lines including either the scanning lines on odd-numbered rows or the scanning lines on even-numbered rows among the n rows of scanning lines is selected, the conduction state of the first transistor of each of the one row of unit circuits coupled to the selected scanning line is set according to the data signal, and when one of the first set of scanning lines including either the scanning lines on the odd-numbered rows or the scanning lines on the even-numbered rows, not included in the second set, is selected, the second transistor of each of the one row of unit circuits coupled to the selected scanning line is turned on to turn off the first transistor.

19. A method of driving an electro-optical apparatus according to claim 13,
wherein, in one frame period, a set operation and a reset operation are executed alternately each time a scanning line is selected, the set operation causing the conduction state of the first transistor of each of unit circuits on one row connected to the selected scanning line, among the plurality of unit circuits, to be set according to the data signal, and the reset operation causing the second transistor of each of the unit circuits on one row coupled to the selected scanning line to be turned on to thereby turn off the first transistor.

20. A method of driving an electro-optical apparatus according to claim 19,
scanning lines on which the set operation is executed and scanning lines on which the reset operation is executed being each selected sequentially from the plurality of scanning lines.

21. A method of driving an electro-optical apparatus according to claim 13,
the electro-optical elements including three types of light-emitting elements that emit light in red, green, and blue, respectively,
and the unit circuits coupled to each of the n rows of scanning lines include one type of light-emitting elements that emit light in the same color among the three types of light-emitting elements.

22. A method of driving an electronic circuit including a first transistor having a first terminal and a second terminal, a second transistor having a third terminal and a fourth terminal, a capacitor commonly coupled to a first control terminal of the first transistor and a second control terminal of the second transistor, a third transistor that controls electrical connection between the third terminal and the second control terminal of the second transistor, the third transistor having a fifth terminal and a sixth terminal; and a fourth transistor having a seventh terminal and an eighth terminal the method comprising:
a first step of turning on the third transistor and the fourth transistor, supplying a signal via the eighth terminal and the seventh terminal so that a charge corresponding to the signal is accumulated in the capacitor, and setting conduction states of the second transistor and the first transistor according to the signal; and
a second step of turning off the fourth transistor and turning on the third transistor to change the conduction states, set in the first step, of the second transistor and the first transistor.

23. The method of driving an electronic circuit according to claim 22,
the first transistor being turned off in the second step.

24. The method of driving an electronic circuit according to claim 22,
the second terminal of the first transistor being electrically coupled to a predetermined potential,
and a potential that is different from the predetermined potential being applied to the first control terminal in the second step.

25. A method of driving an electronic circuit according to claim 22,
an electronic element being connected to the first transistor.

26. A method of driving an electronic circuit according to claim 25,
wherein, in the second step, the first transistor being turned off by the potential applied to the first control terminal, thereby resetting an operation of the electronic element.

27. A method of driving an electronic apparatus including a plurality of first signal lines, a plurality of second signal lines, a plurality of third signal lines, a power-supply line, and a plurality of unit circuits,
each of the plurality of unit circuits including a first transistor having a first terminal and a second terminal, a second transistor having a third terminal and a fourth terminal, a capacitor commonly coupled to a first control terminal of the first transistor and a second control terminal of the second transistor, a third transistor that controls electrical connection between the third terminal and the second control terminal of the second transistor, the third transistor having a fifth terminal and a sixth terminal, and a fourth transistor having a seventh terminal and an eighth terminal;
a third control terminal of the third transistor being coupled to one of the plurality of second signal lines, a fourth control terminal of the fourth transistor being coupled to one of the plurality of first signal lines, and the eighth terminal being coupled to one of the plurality of second signal lines,
the method comprising:
a first step of accumulating a signal supplied via one of the plurality of third signal lines in the capacitor as a charge while the third transistor and the fourth transistor are both on, and setting a conduction state of the first transistor according to the signal; and
a second step of turning off the fourth transistor and turning on the third transistor, and supplying an amount of charge that causes reduction in the conduction state, set in the first step, of the first transistor to the capacitor.

28. A method of driving an electro-optical apparatus including n rows of scanning lines each including a first subscanning line and a second subscanning line, m columns of data lines, a power-supply line, and a plurality of unit circuits arranged in n rows and m columns in association with intersections of the scanning lines and the data lines,
each of the plurality of unit circuits including a first transistor having a first terminal and a second terminal, a second transistor having a third terminal and a fourth terminal, a capacitor commonly coupled to a first control terminal of the first transistor and a second control terminal of the second transistor, a third transistor that controls electrical connection between the third terminal and the second control terminal of the second transistor, the third transistor having a fifth terminal and a sixth terminal, a fourth transistor having a seventh terminal and an eighth terminal, and an electro-optical element connected to the first transistor;
and a third control terminal of the third transistor being coupled to the second subscanning line of one of the n rows of scanning lines, a fourth control terminal of the fourth transistor being coupled to the first subscanning line of the one of the n rows of scanning lines, and the eighth terminal being coupled to one of the m columns of data lines,
the method comprising:
a first step of accumulating a data signal supplied via one of the m columns of data lines in the capacitor as a charge while the third transistor and the fourth transistor are both on, and setting conduction states of the second transistor and the first transistor according to the data signal; and
a second step of turning off the fourth transistor and turning on the third transistor, and supplying an amount of charge that causes reduction in the conduction states, set in the first step, of the second transistor and the first transistor to the capacitor.

29. The method of driving an electro-optical apparatus according to claim 28,
the electro-optical elements including three types of light-emitting elements that emit light in red, green, and blue, respectively,
and the unit circuits coupled to each of the n rows of scanning lines include one type of light-emitting elements that emit light in the same color among the three types of light-emitting elements.

30. The method of driving an electro-optical apparatus according to claim 28,
vertical scanning in which the n rows of scanning lines are sequentially selected one by one being performed at least twice in one frame period,
wherein, in the first time of vertical scanning, when one of a first set of scanning lines including either scanning lines on odd-numbered rows or scanning lines on even-numbered rows among the n rows of scanning lines is selected, the conduction state of the first transistor of each of the one row of unit circuits coupled to the selected scanning line, among the plurality of unit circuits, is set according to the data signal, and when one of a second set of scanning lines including either the scanning lines on the odd-numbered rows or the scanning lines on the even-numbered rows, not included in the first set, is selected, the second transistor of each of the one row of unit circuits coupled to the selected scanning line is turned on to turn off the first transistor,
and wherein, in the second time of vertical scanning, when one of the second set of scanning lines including either the scanning lines on the odd-numbered rows or the scanning lines on the even-numbered rows among the n rows of scanning lines is selected, the conduction state of the first transistor of each of the one row of unit circuits coupled to the selected scanning line is set according to the data signal, and when one of the first set of scanning lines including either the scanning lines on the odd-numbered rows or the scanning lines on the even-numbered rows, not included in the second set, is selected, the second transistor of each of the one row of unit circuits coupled to the selected scanning line is turned on to turn off the first transistor.

31. The method of driving an electro-optical apparatus according to claim 28,
wherein, in one frame period, a set operation and a reset operation are executed alternately each time a scanning line is selected, the set operation causing the conduction state of the first transistor of each of unit circuits on one row coupled to the selected scanning line, among the plurality of unit circuits, to be set according to the data signal, and the reset operation causing the second transistor of each of the unit circuits on one row coupled to the selected scanning line to be turned on to thereby turn off the first transistor, whereby the light-emitting element stops emitting light.

32. The method of driving an electro-optical apparatus according to claim 31,
scanning lines on which the set operation is executed and scanning lines on which the reset operation is executed being each selected sequentially from the plurality of scanning lines.

33. A method of driving an electronic circuit including a first transistor having a first terminal and a second terminal, a capacitor coupled to a first control terminal of the first transistor, a second transistor that controls electrical connection between the first terminal and the capacitor, the second transistor having a third terminal and a fourth terminal, a third transistor electrically coupled to the fourth terminal via the capacitor and electrically coupled to the second terminal of the first transistor, the third transistor having a fifth terminal and a sixth terminal, and a fourth transistor having a seventh terminal coupled to the second terminal and having an eighth terminal, the method comprising:
a first step of turning on the second transistor and the third transistor, supplying a signal via the sixth terminal and the fifth terminal so that a charge corresponding to the signal is accumulated in the capacitor, and setting a conduction state of the first transistor according to the signal; and
a second step of turning off the fourth transistor to change the conduction state, set in the first step, of the first transistor.

34. A method of driving an electronic apparatus including a plurality of first signal lines, a plurality of second signal lines, a plurality of third signal lines, a power-supply line, and a plurality of unit circuits,
each of the plurality of unit circuits including a first transistor having a first terminal and a second terminal, a capacitor coupled to a first control terminal of the first transistor, a second transistor that controls electrical connection between the first terminal and the capacitor, the second transistor having a third terminal and a fourth terminal, a third transistor electrically coupled to the fourth terminal and the first control terminal of the first transistor via the capacitor, the third transistor having a fifth terminal and a sixth terminal, and a fourth transistor having a seventh terminal coupled to the second terminal and having an eighth terminal;
and a second control terminal of the second transistor is coupled to one of the plurality of second signal lines, a third control terminal of the third transistor is coupled to one of the plurality of first signal lines, and the sixth terminal is coupled to one of the plurality of third signal lines,
the method comprising:
a first step of accumulating a signal supplied via one of the third signal lines in the capacitor as a charge while the second transistor and the third transistor are both on, and setting a conduction state of the first transistor according to the signal; and
a second step of turning off the fourth transistor.

35. A method of driving an electro-optical apparatus including n rows of scanning lines each including a first subscanning line and a second subscanning line, m columns of data lines, a power-supply line, and a plurality of unit circuits arranged in n rows and m columns in association with intersections of the scanning lines and the data lines,
each of the plurality of unit circuits including a first transistor having a first terminal and a second terminal, a capacitor coupled to a first control terminal of the first transistor, a second transistor that controls electrical connection between the first terminal and the capacitor, the second transistor having a third terminal and a fourth terminal, a third transistor electrically coupled to the fourth terminal and the first control terminal of the first transistor via the capacitor, the third transistor having a fifth terminal and a sixth terminal, a fourth transistor having a seventh terminal coupled to the second terminal and having an eighth terminal, and an electro-optical element coupled to the first transistor;
and a second control terminal of the second transistor being coupled to the second subscanning line of one of the n rows of scanning lines, a third control terminal of the third transistor being coupled to the first subscanning line of the one of the n rows of scanning lines, and the sixth terminal being coupled to one of the m columns of data lines,
the method comprising:
a first step of accumulating a data signal supplied via one of the m columns of data lines in the capacitor as a charge while the second transistor and the third transistor are both on, and setting a conduction state of the first transistor according to the data signal; and
a second step of turning off the fourth transistor.

36. An electronic device, wherein a driving method according to claim 1 is used.
